(19) United States
(12) Patent Application Publication
(10) Pub. No.: US 2025/0262874 A1
(43) Pub. Date: Aug. 21, 2025

(54) MEDIUM TRANSPORT DEVICE, RECORDING DEVICE, AND CONTROL METHOD FOR MEDIUM TRANSPORT DEVICE

(71) Applicant: SEIKO EPSON CORPORATION, Tokyo (JP)

(72) Inventors: Yoshikazu KOIKE, CHINO-SHI (JP); Kazuhiro KOBAYASHI, SHIOJIRI-SHI (JP)

(21) Appl. No.: 19/055,577

(22) Filed: Feb. 18, 2025

(30) Foreign Application Priority Data
Feb. 20, 2024 (JP) 2024-023562

(51) Int. Cl. B41J 13/00; B41J 13/03; B41J 13/08; B41J 13/26

(52) U.S. Cl. CPC B41J 13/0018; B41J 13/03; B41J 13/08; B41J 13/26

(57) ABSTRACT

A medium transport device includes a feed roller that feeds a medium; a transport roller that transports the medium fed by the feed roller; a registration roller that corrects skew of the medium transported by the transport roller; a transport path extending from the feed roller toward the registration roller; and a control section that rotates the transport roller so as to transport the medium at a first speed and that rotates the registration roller so as to transport the medium at a second speed that is higher than the first speed, wherein the transport path includes a curved portion extending while curving between the transport roller and the registration roller and the control section rotates the feed roller such that a subsequent medium fed next after a preceding medium overlaps the preceding medium until a leading edge of the preceding medium reaches the registration roller.

The present application is based on, and claims priority from JP Application Serial Number 2024-023562, filed Feb. 20, 2024, the disclosure of which is hereby incorporated by reference herein in its entirety.

### BACKGROUND

### 1. Technical Field

The present disclosure relates to a medium transport device, a recording device, and a control method for a medium transport device.

### 2. Related Art

JP-A-2017-109837 describes a medium transport device that includes a feed roller that feeds a medium, a transport roller that transports the fed medium, and a registration roller that corrects skew of the transported medium. The registration roller corrects skew of the medium when a leading edge of the medium abuts against the registration roller. The transport roller transports the medium along a transport path that includes a curved portion.

In such a medium transport device, if the leading edge of the medium rubs against the curved portion, paper dust may be generated from the medium or the medium may be charged. Therefore, it is necessary to transport the medium at a low speed in the curved portion. However, when the medium is transported at a low speed, a processing speed of the medium decreases.

### SUMMARY

A medium transport device that overcomes the above-described problem includes a feed roller that feeds a medium; a transport roller that transports the medium fed by the feed roller; a registration roller that corrects skew of the medium transported by the transport roller; a transport path extending from the feed roller toward the registration roller; and a control section that rotates the transport roller so as to transport the medium at a first speed and that rotates the registration roller so as to transport the medium at a second speed that is higher than the first speed, wherein the transport path includes a curved portion extending while curving between the transport roller and the registration roller and the control section rotates the feed roller such that a subsequent medium fed next after a preceding medium overlaps the preceding medium until a leading edge of the preceding medium reaches the registration roller.

A recording device that overcomes the above-described problem includes the above-described medium transport device and a recording section that records an image on the medium transported by the medium transport device, wherein the medium transport device continuously transports the medium on which recording is being performed by the recording section.

A recording device that overcomes the above-described problem includes the above-described medium transport device and a recording section that records an image on the medium transported by the medium transport device.

A control method that overcomes the above-described problem for a medium transport device, the medium transport device including a feed roller that feeds a medium, a transport roller that transports the medium fed by the feed roller, a registration roller that corrects skew of the medium transported by the transport roller, and a transport path extending from the feed roller toward the registration roller, wherein the transport path includes a curved portion extending while curving between the transport roller and the registration roller, the control method includes rotating the transport roller so as to transport the medium whose leading edge is positioned on the transport path at a first speed; rotating the registration roller so as to transport the medium whose leading edge has reached the registration roller at a second speed that is higher than the first speed; and rotating the feed roller such that a subsequent medium fed after a preceding medium overlaps with the preceding medium until a leading edge of the preceding medium reaches the registration roller.

A control method that overcomes the above-described problem for a medium transport device, the medium transport device including a feed roller that feeds a medium, a transport roller that transports the medium fed by the feed roller, a registration roller that corrects skew of the medium transported by the transport roller, and a transport path extending from the feed roller toward the registration roller, wherein the transport path includes a curved portion extending while curving between the transport roller and the registration roller, and an upstream portion positioned upstream of the curved portion and having a curvature smaller than that of the curved portion, the control method includes rotating the transport roller so as to transport the medium whose leading edge is positioned at the curved portion at a first speed; rotating the transport roller so as to transport the medium whose leading edge is positioned at the upstream portion at a second speed that is higher than the first speed; rotating the registration roller so as to transport the medium whose leading edge has reached the registration roller at the second speed; and rotating the feed roller such that a subsequent medium fed after a preceding medium overlaps with the preceding medium until a leading edge of the preceding medium reaches the registration roller.

### BRIEF DESCRIPTION OF THE DRAWINGS

FIG. 1 is a schematic diagram showing an embodiment of a recording device that includes a medium transport device.

FIG. 2 is a schematic diagram when a preceding medium is fed.

FIG. 3 is a schematic diagram when a subsequent medium is fed.

FIG. 4 is a schematic diagram when the subsequent medium is fed while being overlapped on the preceding medium.

FIG. 5 is a schematic diagram when a leading edge of the preceding medium reaches a registration roller in a first pattern.

FIG. 6 is a schematic diagram when a trailing edge of the preceding medium has passed a third transport roller in the first pattern.

FIG. 7 is a schematic diagram when the trailing edge of the preceding medium has passed a second transport roller in the first pattern.

FIG. 8 is a schematic diagram when the trailing edge of the preceding medium has passed a first transport roller in the first pattern.

FIG. 9 is a schematic diagram when the trailing edge of the preceding medium has passed the registration roller in the first pattern.

FIG. 10 is a schematic diagram when a leading edge of the subsequent medium reaches the registration roller in the first pattern.

FIG. 11 is a schematic diagram when the leading edge of the preceding medium reaches the registration roller in a second pattern.

FIG. 12 is a schematic diagram when the trailing edge of the preceding medium has passed the third transport roller in the second pattern.

FIG. 13 is a schematic diagram when the trailing edge of the preceding medium has passed the second transport roller in the second pattern.

FIG. 14 is a schematic diagram when the trailing edge of the preceding medium has passed the first transport roller in the second pattern.

FIG. 15 is a schematic diagram when the trailing edge of the preceding medium has passed the registration roller in the second pattern.

FIG. 16 is a schematic diagram when the leading edge of the subsequent medium reaches the registration roller in the second pattern.

FIG. 17 is a flowchart showing a first transport process.

FIG. 18 is a flowchart showing an overlap forming process.

FIG. 19 is a flowchart showing a second transport process.

### DESCRIPTION OF EMBODIMENTS

An embodiment of a recording device that includes a medium transport device will be described below with reference to the drawings. The recording device is, for example, an inkjet type printer that records an image such as a character or a photograph by ejecting ink, which is an example of liquid, onto a medium that is a paper sheet.

### Recording Device

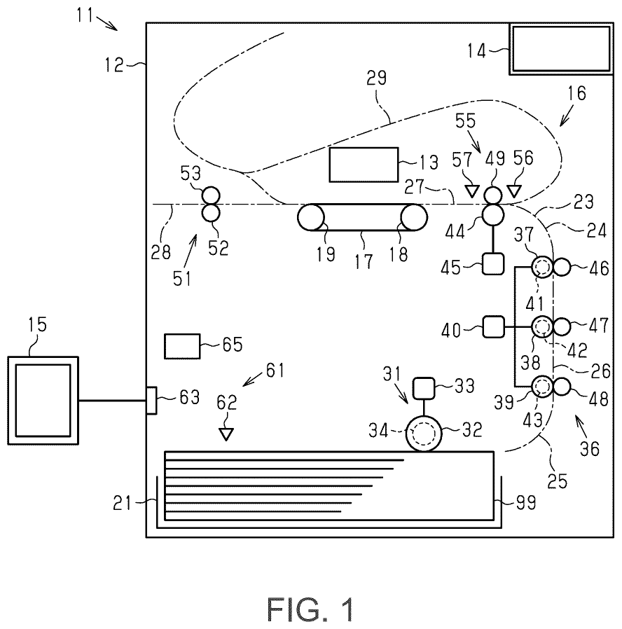

As shown in FIG. 1, a recording device 11 includes a housing 12.

The recording device 11 includes a recording section 13. The recording section 13 is configured to record an image on a medium 99. In one example, the recording section 13 records an image on the medium 99 by ejecting liquid onto the medium 99. The recording section 13 is configured to simultaneously eject liquid across the entire width of the medium 99. The recording section 13 is a so-called line head. The recording section 13 may be configured to eject liquid while scanning the medium 99. In this case, the recording section 13 is a so-called serial head. The recording section 13 is not limited to an inkjet, and may record an image on the medium 99 by fixing toner to the medium 99. The recording device 11 is not limited to an inkjet printer and may be a laser printer.

The recording device 11 may include an operation section 14. A user operates the recording device 11 through the operation section 14. A user inputs information to the recording device 11 or gives an instruction to the recording device 11 by operating the operation section 14. The operation section 14 is, for example, a touch-screen. The operation section 14 may include a switch, a button, a lever, or the like.

The recording device 11 may be configured to communicate with a control device 15. A user operates the recording device 11 by operating the control device 15. By operating the control device 15, the user inputs information to the recording device 11 and gives an instruction to the recording device 11. The control device 15 is a smartphone, a personal computer, or the like.

The recording device 11 includes a medium transport device 16. The medium transport device 16 is configured to transport the medium 99. The medium transport device 16 transports the medium 99 within the housing 12. In the recording device 11, the medium transport device 16 transports the medium 99 before recording to the recording section 13. That is, the recording section 13 records an image on the medium 99 transported by the medium transport device 16. In one example, the medium transport device 16 continuously transports the medium 99 during recording. This is because the recording section 13 is a line head. Since the line head can simultaneously eject liquid across the entire width of the medium 99, it is not necessary to stop the medium 99 during recording. When recording section 13 is a serial head, the medium transport device 16 intermittently transports the medium 99 during recording. In a case of the serial head, it is necessary to stop the transport of the medium 99 while the recording section 13 scans the medium 99. In the recording device 11, the medium transport device 16 discharges the recorded medium 99 from the housing 12.

### Medium Transport Device

The medium transport device 16 may include a transport belt 17. The transport belt 17 faces the recording section 13. The transport belt 17 supports the medium 99. The transport belt 17 supports the medium 99 during recording. The medium transport device 16 may include a support section that supports the medium 99 instead of the transport belt 17.

The medium transport device 16 is configured to attract the medium 99 to the transport belt 17. In one example, the medium 99 is attracted to the transport belt 17 by an electrostatic force. By this, the posture of the medium 99 is stabilized on the transport belt 17. As a result, the recording quality is improved. Not limited to an electrostatic force, the medium 99 may be attracted to the transport belt 17 by, for example, a negative pressure due to suction.

The transport belt 17 is configured to transport the medium 99. The transport belt 17 is configured to transport the medium 99 while attracting the medium 99. The transport belt 17 transports the medium 99 by rotating. In one example, the transport belt 17 continuously transports the medium 99. That is, the transport belt 17 transports the medium 99 during recording without stopping the medium 99. The transport belt 17 may transport the medium 99 intermittently. In this case, the transport belt 17 and the recording section 13 repeat the transport, stop, and recording of the medium 99 in order.

The medium transport device 16 may include a plurality of pulleys. In one example, the medium transport device 16 includes a first pulley 18 and a second pulley 19. The transport belt 17 is wound around the first pulley 18 and the second pulley 19. When the first pulley 18 and the second pulley 19 rotate, the transport belt 17 rotates.

The medium transport device 16 includes a stacking section 21. The stacking section 21 is configured to stack a plurality of sheets of the medium 99. The medium 99 before recording is stacked on the stacking section 21. In one example, the stacking section 21 is a cassette. The stacking section 21 is configured to be insertable into and removable from the housing 12. The stacking section 21 is not limited to a cassette and may be a tray.

The medium transport device 16 includes a transport path 23. The transport path 23 is a path on which the medium 99 is transported. The transport path 23 extends from the stacking section 21. In one example, the transport path 23 extends from the stacking section 21 toward the recording section 13. The transport path 23 extends from the stacking section 21 to the recording section 13 while curving. The medium 99 is transported from the stacking section 21 to the recording section 13 through the transport path 23.

The transport path 23 includes one or more curved portions. In one example, the transport path 23 includes a first curved portion 24 and a second curved portion 25. The curved portion is a portion that curves in the transport path 23. The first curved portion 24 is positioned downstream of the second curved portion 25 in the transport path 23.

The transport path 23 includes an upstream portion 26. The upstream portion 26 is positioned upstream of the first curved portion 24 in the transport path 23. The curvature of the upstream portion 26 is smaller than the curvature of the first curved portion 24. The curvature of the upstream portion 26 is smaller than the curvature of the second curved portion 25. In one example, the upstream portion 26 is a portion extending linearly upstream of the first curved portion 24 in the transport path 23. The upstream portion 26 is connected to the first curved portion 24. In one example, the upstream portion 26 is positioned between the first curved portion 24 and the second curved portion 25. The upstream portion 26 is connected to the first curved portion 24 and the second curved portion 25.

The upstream portion 26 is not limited to a portion extending linearly. In other words, in a case where the medium 99 is transported at a second speed that is relatively high, the upstream portion 26 may include a portion that is curved to such an extent that a problem such as generation of paper dust or charging is unlikely to occur. Therefore, it can be said that the curved portion is a portion that is curved to such an extent that a problem such as generation of paper dust or charging is likely to occur in a case where the medium 99 is transported at a second speed that is relatively high.

The transport path 23 may include a connection portion 27. The connection portion 27 is a portion that is connected to the transport belt 17 in the transport path 23. The medium 99 is transported to the transport belt 17 through the connection portion 27. The connection portion 27 is positioned downstream of the first curved portion 24 in the transport path 23. The connection portion 27 is connected to the first curved portion 24. The connection portion 27 extends linearly from the first curved portion 24 toward the transport belt 17.

The medium transport device 16 may include a discharge path 28. The discharge path 28 is a path through which the medium 99 is discharged. In one example, the discharge path 28 is a path through which the recorded medium 99 is discharged. The discharge path 28 extends from the transport belt 17 toward the outside of the housing 12. The medium 99 is discharged to the outside of the housing 12 through the discharge path 28.

The medium transport device 16 may include a re-transport path 29. The re-transport path 29 is a path that extends from the discharge path 28 to the transport path 23. The medium 99 is returned from the discharge path 28 to the transport path 23 through the re-transport path 29. The medium 99 is switched back in the re-transport path 29. Therefore, when the medium 99 is returned from the discharge path 28 to the transport path 23 through the re-transport path 29, the front and back of the medium 99 is inverted. By this, the recording device 11 can record images on both sides of the medium 99.

The medium transport device 16 includes a feed section 31. The feed section 31 is configured to feed the medium 99. The feed section 31 feeds the medium 99 from the stacking section 21. Specifically, the feed section 31 feeds the medium 99 toward a transport section 36 (to be described later).

The feed section 31 feeds the medium 99 along the transport path 23. Specifically, the feed section 31 feeds the medium 99 to the transport section 36 along the transport path 23. The feed section 31 feeds the medium 99 to the transport section 36 through the second curved portion 25.

The feed section 31 includes a feed roller 32. The feed roller 32 feeds the medium 99 by rotating. The feed roller 32 is positioned so as to be in contact with the medium 99 stacked on the stacking section 21. In one example, the feed roller 32 contacts the uppermost medium 99 among the medium 99 stacked on the stacking section 21. The feed roller 32 feeds a sheet of the medium 99 one by one from the stacking section 21. The feed roller 32 feeds the medium 99 along the transport path 23. The feed roller 32 feeds the medium 99 along the second curved portion 25.

The feed section 31 includes a feed motor 33. The feed motor 33 is connected to the feed roller 32. The feed roller 32 is rotated by a power of the feed motor 33.

The feed section 31 includes a feed clutch 34. The feed clutch 34 is connected to the feed roller 32 and the feed motor 33. The feed clutch 34 is positioned between the feed roller 32 and the feed motor 33. The feed clutch 34 is configured to transmit the power of the feed motor 33 to the feed roller 32. The feed clutch 34 is configured to be able to interrupt power transmission between the feed roller 32 and the feed motor 33. When the feed clutch 34 interrupts power transmission, the feed roller 32 does not apply a feed force to the medium 99. In this case, the feed roller 32 can be rotated following the medium 99.

The medium transport device 16 includes the transport section 36. The transport section 36 is configured to transport the medium 99. The transport section 36 transports the medium 99 fed by the feed section 31. The transport section 36 transports the medium 99 along the transport path 23. In one example, the transport section 36 transports the medium 99 toward the recording section 13.

The transport section 36 includes one or more transport rollers. In one example, the transport section 36 includes three transport rollers. The transport section 36 includes a first transport roller 37, a second transport roller 38, and a third transport roller 39. The transport rollers transport the medium 99 fed by the feed roller 32.

A plurality of transport rollers are arranged along the transport path 23. The first transport roller 37, the second transport roller 38, and the third transport roller 39 are arranged in this order from downstream to upstream of the transport path 23. That is, the first transport roller 37 is positioned downstream of the second transport roller 38 and the third transport roller 39 in the transport path 23. The second transport roller 38 is positioned downstream of the third transport roller 39 in the transport path 23. In one example, the first transport roller 37, the second transport roller 38, and the third transport roller 39 are positioned in the upstream portion 26. The transport roller may be positioned in the curved portion. For example, the first transport roller 37 may be positioned in the first curved portion 24. The first transport roller 37 may be positioned upstream of a portion having the largest curvature in the first curved portion 24. The third transport roller 39 may be positioned in the second curved portion 25. The third transport roller 39 may be positioned downstream of a portion having the largest curvature in the second curved portion 25. Therefore, it can be said that the second curved portion 25 is a portion extending while curving between the feed roller 32 and the transport roller.

The transport section 36 may be configured such that the rotation speed of the transport roller is variable. The transport section 36 may change the rotation speed of the transport roller by an applied voltage, or may change the rotation speed of the transport roller by a reduction ratio.

The transport section 36 includes a transport motor 40. The transport motor 40 is connected to the transport roller. In one example, the transport motor 40 is connected to the first transport roller 37, the second transport roller 38, and the third transport roller 39. The first transport roller 37, the second transport roller 38, and the third transport roller 39 are each rotated by a power of the transport motor 40. The transport section 36 may include the transport motor 40 for each transport roller.

The transport section 36 may include one or more transport clutches. In one example, the transport section 36 includes three transport clutches. The transport section 36 includes a first transport clutch 41, a second transport clutch 42, and a third transport clutch 43.

The transport clutch is connected to the transport roller and the transport motor 40. The first transport clutch 41 is connected to the first transport roller 37 and the transport motor 40. The second transport clutch 42 is connected to the second transport roller 38 and the transport motor 40. The third transport clutch 43 is connected to the third transport roller 39 and the transport motor 40.

The transport clutch is positioned between the transport roller and the transport motor 40. The first transport clutch 41 is positioned between the first transport roller 37 and the transport motor 40. The second transport clutch 42 is positioned between the second transport roller 38 and the transport motor 40. The third transport clutch 43 is positioned between the third transport roller 39 and the transport motor 40.

The transport clutch is configured to transmit the power of the transport motor 40 to the transport roller. The first transport clutch 41 is configured to transmit the power of the transport motor 40 to the first transport roller 37. The second transport clutch 42 is configured to transmit the power of the transport motor 40 to the second transport roller 38. The third transport clutch 43 is configured to transmit the power of the transport motor 40 to the third transport roller 39.

The transport clutch is configured to be able to interrupt power transmission between the transport roller and the transport motor 40. The first transport clutch 41 is configured to be able to interrupt power transmission between the first transport roller 37 and the transport motor 40. When the first transport clutch 41 interrupts power transmission, the first transport roller 37 is in a state in which it does not apply a transporting force to the medium 99. In this case, the first transport roller 37 can be rotated following the medium 99. The second transport clutch 42 is configured to be able to interrupt power transmission between the second transport roller 38 and the transport motor 40. When the second transport clutch 42 interrupts power transmission, the second transport roller 38 is in a state in which it does not apply a transporting force to the medium 99. In this case, the second transport roller 38 can be rotated following the medium 99. The third transport clutch 43 is configured to be able to interrupt power transmission between the third transport roller 39 and the transport motor 40. When the third transport clutch 43 interrupts power transmission, the third transport roller 39 is in a state in which it does not apply a transporting force to the medium 99. In this case, the third transport roller 39 can be rotated following the medium 99.

The transport section 36 may be configured to move the transport roller. For example, the transport section 36 may move the transport roller so as to be switched between a state of being in contact with the medium 99 and a state of being separated from the medium 99. That is, the transport roller may be configured to be movable to a position where it does not come into contact with the medium 99 passing through the transport path 23. When the transport roller is separated from medium 99, it does not apply a transporting force to medium 99.

The transport section 36 includes a registration roller 44. The registration roller 44 is a roller that corrects skew of the medium 99. Specifically, skew of the medium 99 is corrected when the medium 99 is abutted against the stopped registration roller 44. The medium 99 transported along the transport path 23 abuts against the registration roller 44.

The registration roller 44 is positioned downstream of the transport roller in the transport path 23. The medium 99 transported by the transport roller abuts against the registration roller 44. Therefore, it can be said that the transport path 23 extends from the feed roller 32 toward the registration roller 44. The registration roller 44 corrects skew of the medium 99 transported by the transport roller. The registration roller 44 transports the medium 99 transported by the transport roller.

The registration roller 44 is positioned downstream of the first curved portion 24. Specifically, the registration roller 44 is positioned downstream of a portion having the largest curvature in the first curved portion 24. Therefore, a leading edge of the medium 99 reaches the registration roller 44 after passing through a portion having the largest curvature in the first curved portion 24. In one example, the registration roller 44 is positioned downstream of the first curved portion 24. The registration roller 44 is positioned, for example, at the connection portion 27. The registration roller 44 may be positioned at the first curved portion 24 as long as the registration roller 44 is positioned downstream of a portion having the largest curvature in the first curved portion 24. From these facts, it can be said that the first curved portion 24 is a portion extending while curving between the transport roller and the registration roller 44. In one example, the first curved portion 24 is positioned between the upstream portion 26 and the registration roller 44.

The registration roller 44 is positioned upstream of the transport belt 17 in the transport path 23. The registration roller 44 transports the medium 99 transported by the transport roller to the transport belt 17. The registration roller 44 transports the medium 99 during recording. In one example, the registration roller 44, together with the transport belt 17, transports the medium 99 during recording. Therefore, the registration roller 44 transports the medium 99 at the same speed as the transport belt 17.

The transport section 36 includes a registration motor 45. The registration motor 45 is connected to the registration roller 44. The registration roller 44 rotates by a power of the registration motor 45. The transport section 36 may include a registration clutch that transmits a power between the registration motor 45 and the registration roller 44 and interrupts power transmission.

The transport section 36 includes a plurality of driven rollers. The transport section 36 includes a driven roller facing the transport roller and a driven roller facing the registration roller 44. In one example, the transport section 36 includes a first driven roller 46, a second driven roller 47, a third driven roller 48, and a fourth driven roller 49. The driven roller is driven to rotate by a facing roller. The first driven roller 46 faces the first transport roller 37. The second driven roller 47 faces the second transport roller 38. The third driven roller 48 faces the third transport roller 39. The fourth driven roller 49 faces the registration roller 44.

The medium transport device 16 includes a discharge section 51. The discharge section 51 is configured to discharge the medium 99. The discharge section 51 discharges the medium 99 along the discharge path 28. The discharge section 51 includes a discharge roller 52. The discharge section 51 includes a sub-roller 53. The sub-roller 53 faces the discharge roller 52.

The medium transport device 16 includes a detection section 55. The detection section 55 is configured to detect the medium 99. The detection section 55 detects the medium 99 transported on the transport path 23. The detection section 55 includes one or more detection sensors. In one example, the detection section 55 includes a first detection sensor 56 and a second detection sensor 57. The detection sensor is, for example, an optical sensor. The first detection sensor 56 is positioned upstream of the second detection sensor 57 in the transport path 23. The first detection sensor 56 is positioned upstream of the registration roller 44 in the transport path 23. The second detection sensor 57 is positioned downstream of the registration roller 44 in the transport path 23. The medium transport device 16 recognizes that the medium 99 reaches the registration roller 44 when the first detection sensor 56 detects a leading edge of the medium 99. The medium transport device 16 recognizes that the medium 99 reaches the recording section 13 when the second detection sensor 57 detects the leading edge of the medium 99. When the second detection sensor 57 detects a trailing edge of the medium 99, the medium transport device 16 recognizes that the medium 99 has passed the registration roller 44.

The medium transport device 16 may include an acquisition section 61. The acquisition section 61 is configured to acquire information relating to transport of the medium 99. The information relating to transport of medium 99 includes, for example, the size of medium 99, the type of medium 99, and the setting of a transport method. In the recording device 11, the information relating to transport of the medium 99 includes the setting of a recording method. The transport method is a high-speed transport that emphasizes a processing speed, a low-speed transport that emphasizes quality, or the like. The recording method includes double-sided recording, single-sided recording, monochrome recording, and full-color recording.

The acquisition section 61 may include an acquisition sensor 62. The acquisition sensor 62 is, for example, an optical sensor. The acquisition sensor 62 is positioned to face the medium 99 stacked on the stacking section 21. The acquisition sensor 62 acquires information relating to transport of the medium 99 from the medium 99. The acquisition sensor 62 acquires the size of the medium 99, the type of the medium 99, and the like by irradiating the medium 99 with light, for example.

The acquisition section 61 includes a connection body 63. The connection body 63 is, for example, an interface connected to the operation section 14, the control device 15, and the like. The connection body 63 acquires information relating to transport of the medium 99 from a user through the operation section 14, the control device 15, and the like. That is, the connection body 63 acquires the size of the medium 99, the type of the medium 99, the setting of the transport method, the setting of the recording method, and the like, which are set through the operation section 14, the control device 15, and the like.

The medium transport device 16 includes a control section 65. The control section 65 controls the medium transport device 16. The control section 65 controls the transport belt 17, the first pulley 18, the second pulley 19, the feed section 31, the transport section 36, the discharge section 51, and the like. The control section 65 may control the recording device 11. For example, the control section 65 may control the recording section 13.

The control section 65 may be constituted by one or more processors that execute various processes in accordance with a computer program. The control section 65 may be configured by one or more dedicated hardware circuits such as an ASIC that executes at least a part of various processes. The control section 65 may be configured as a circuit including a combination of a processor and a hardware circuit. The processor includes a CPU and memory such as a RAM and a ROM. The memory stores program code or commands configured to cause the CPU to perform processes. Memory, that is computer-readable medium, includes any readable medium that can be accessed by a general-purpose or dedicated computer.

The control section 65 controls the feed section 31 and the transport section 36, thereby transporting the medium 99 on the transport path 23. At this time, if a leading edge of the medium 99 rubs against the curved portion, paper dust may be generated from the medium 99 or the medium 99 may be charged. In order to suppress the generation of paper dust and charging, the medium transport device 16 needs to transport the medium 99, whose leading edge is positioned in the curved portion, at a low speed.

The control section 65 controls the feed section 31 and the transport section 36 so as to transport the medium 99, whose leading edge is positioned in the curved portion, at a low speed. Specifically, the control section 65 rotates the feed roller 32 so as to feed the medium 99 at a first speed. The control section 65 rotates the transport roller so as to transport the medium 99 at the first speed. The control section 65 rotates the registration roller 44 to transport the medium 99 at a second speed. The second speed is higher than the first speed. In one example, the second speed is the speed of medium 99 during recording. By causing the medium 99 to be transported at a speed relatively lower than the second speed, the control section 65 suppresses the generation of paper dust, charging, and the like, as compared with a case where the medium 99 is always transported at the second speed.

When medium 99 is transported at a low speed, a processing speed may be reduced. That is, the time required to transport the medium 99 may increase. When the transport roller transports the medium 99 at a low speed relative to the registration roller 44, the transport interval of sheets of the medium 99 may increase. In one example, there is a possibility that the arrival interval of sheets of medium 99 with respect to the recording section 13 increases.

The control section 65 controls the feed section 31 and the transport section 36 so as to reduce the transport interval of sheets of the medium 99. In one example, the control section 65 controls the feed section 31 and the transport section 36 so as to reduce the arrival interval of sheets of the medium 99 with respect to the recording section 13. By this, a decrease in a processing speed is suppressed.

The control section 65 controls the feed section 31 and the transport section 36 such that sheets of the medium 99 are transported while overlapping each other in order to reduce the transport interval of sheets of the medium 99. Specifically, the control section 65 controls the feed section 31 and the transport section 36 such that sheets of the medium 99 are transported while overlapping each other. The control section 65 rotates the feed roller 32 and the transport roller such that sheets of the medium 99 are transported while overlapping each other. The control section 65 suppresses a decrease in a processing speed by overlapping sheets of the medium 99.

Due to the speed difference between the registration roller 44 and the transport roller, the overlap between sheets of the medium 99 is gradually eliminated. That is, the overlap between sheets of the medium 99 is gradually eliminated in a process of being transported on the transport path 23. As the timing at which the overlap between sheets of the medium 99 is eliminated is later, a processing speed is improved. For example, the arrival interval of sheets of the medium 99 with respect to the recording section 13 decreases as the timing at which the overlap between sheets of the medium 99 is eliminated is later.

While the later the timing at which the overlap between sheets of medium 99 is eliminated, the higher a processing speed, if the timing at which the overlap between sheets of medium 99 is eliminated is too late, there is a possibility that the quality is degraded. For example, when sheets of the medium 99 reach the recording section 13 while overlapping each other, there is a possibility that the recording quality may be affected. For example, when sheets of the medium 99 reach the transport belt 17 while overlapping each other, there is a possibility that the recording quality may be affected. Therefore, the overlap between a preceding medium 99 and a subsequent medium 99 needs to be eliminated at least before the subsequent medium 99 reaches the recording section 13. Desirably, the overlap between the preceding medium 99 and the subsequent medium 99 is eliminated before the subsequent medium 99 reaches the transport belt 17. In this case, the medium 99 is effectively attracted to the transport belt 17. More desirably, the overlap between the preceding medium 99 and the subsequent medium 99 may be eliminated before the subsequent medium 99 reaches the registration roller 44. In this case, the subsequent medium 99 can be abutted against the registration roller 44. That is, skew can be corrected for the subsequent medium 99 without stopping the transport of the preceding medium 99.

In order to reduce the transport interval of sheets of the medium 99, the control section 65 transports the sheets of medium 99 so as to eliminate the overlap between sheets of the medium 99. Specifically, the control section 65 controls the feed section 31 and the transport section 36 so as to eliminate the overlap between sheets of the medium 99. The control section 65 rotates the feed roller 32 and the transport roller so as to eliminate the overlap between sheets of the medium 99. The control section 65 suppresses a decrease in the quality by eliminating the overlap between sheets of the medium 99.

The control section 65 may be configured to be able to execute a first mode and a second mode. The first mode is a mode in which sheets of medium 99 are transported while overlapping each other. The second mode is a mode in which sheets of the medium 99 are transported without overlapping each other. Specifically, the first mode is a mode in which the feed roller 32 rotates so that the preceding medium 99 and the subsequent medium 99 overlap each other. The second mode is a mode in which the feed roller 32 rotates so that the preceding medium 99 and the subsequent medium 99 do not overlap each other.

The control section 65 selects the first mode or the second mode based on the operation of the operation section 14, the control device 15, or the like by a user. For example, when the user places importance on suppression of generation of paper dust or suppression of charging, the control section 65 can select the first mode. When the user places importance on a processing speed rather than suppression of paper dust generation or suppression of charging, the control section 65 can select the second mode and set a transport speed to the second speed that is relatively high. In addition to this, for example, when the user places importance on the suppression of paper dust generation and suppression of charging while placing importance on a processing speed, the control section 65 can select the first mode. When the user places importance to the quality while placing importance to suppression of paper dust generation and suppression of charging, the control section 65 can select the second mode and set a transport speed to the first speed that is relatively low. By this, the medium transport device 16 can operate in accordance with the user's needs.

### Control of Medium Transport Device

Next, a control of the medium transport device 16 by the control section 65 will be described in terms of transporting sheets of the medium 99 while overlapping each other.

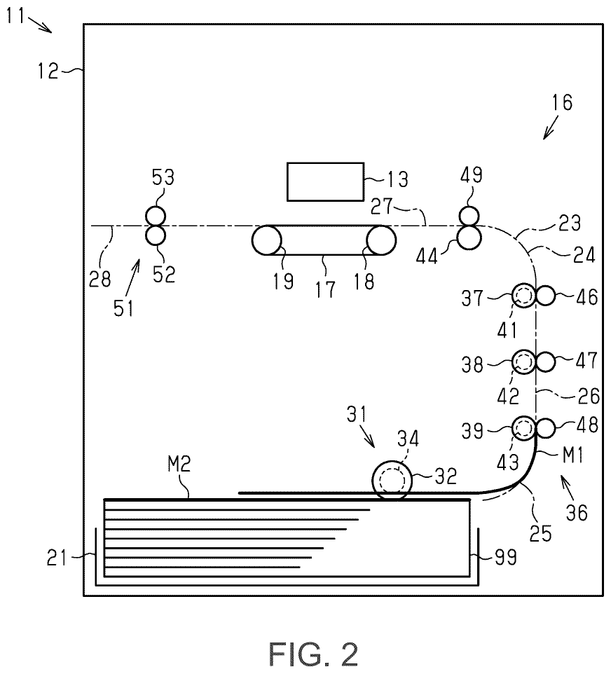

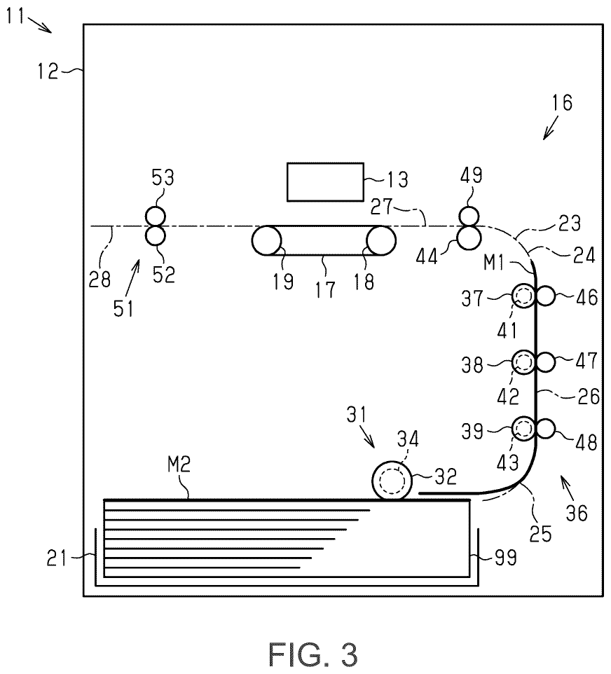

As shown in FIGS. 2, 3, and 4, the control section 65 controls the feed section 31 such that sheets of the medium 99 are fed while overlapping each other. The control section 65 rotates the feed roller 32 so as to feed sheets of the medium 99 while overlapping each other. The control section 65 rotates the feed roller 32 so that a preceding medium M1 and a subsequent medium M2 are fed while overlapping each other. The preceding medium M1 is the medium 99, which precedes the subsequent medium M2. The preceding medium M1 is, for example, a first sheet of the medium 99. The subsequent medium M2 is the medium 99 subsequent to the preceding medium M1. The subsequent medium M2 is medium 99 to be fed next to the preceding medium M1. The subsequent medium M2 is, for example, a second sheet of the medium 99. The control section 65 rotates the feed roller 32 such that a leading edge portion of the subsequent medium M2 overlaps a trailing edge portion of the preceding medium M1.

The control section 65 controls the rotation timing of the feed roller 32 to feed sheets of the medium 99 overlapping each other. For example, the control section 65 controls the rotation timing of the feed roller 32 by controlling the feed clutch 34. Specifically, the control section 65 controls the rotation timing of the feed roller 32 by transmitting or interrupting a power. The control section 65 controls the rotation timing of the feed roller 32 by turning on and off the feed clutch 34. When the feed clutch 34 is turned on, a power is transmitted to the feed roller 32. When the feed clutch 34 is turned off, power transmission of the feed roller 32 is interrupted. The control section 65 repeatedly turns the feed clutch 34 on and off, thereby feeding sheets of the medium 99 while overlapping each other. In one example, the control section 65 turns on the feed clutch 34 before the fed preceding medium M1 passes the stacking section 21, thereby feeding the subsequent medium M2 while overlapping the subsequent medium M2 on the preceding medium M1.

The control section 65 may rotate the feed roller 32 so as to sequentially overlap the subsequent medium 99 with respect to the preceding medium 99. For example, the control section 65 may rotate the feed roller 32 so as to overlap a third sheet of the medium 99 on a second sheet of the medium 99.

The control section 65 may rotate the feed roller 32 such that an even-numbered sheet of the medium 99 is overlapped on an odd-numbered sheet of the medium 99. For example, the control section 65 may rotate the feed roller 32 so as to overlap a second sheet of the medium 99 on a first sheet of the medium 99 and then rotate the feed roller 32 so as to overlap a fourth sheet of the medium 99 on a third sheet of the medium 99.

The control section 65 may feed the medium 99 while appropriately changing the way of overlapping sheets of the medium 99. For example, the control section 65 may rotate the feed roller 32 such that a second sheet of the medium 99 is overlapped on a first sheet of the medium 99, and then rotate the feed roller 32 such that third and subsequent sheets of medium 99 are sequentially overlapped.

The control section 65 rotates the feed roller 32 to feed the medium 99 at the first speed. Specifically, the control section 65 rotates the feed roller 32 so as to feed the medium 99, whose leading edge is positioned in the second curved portion 25, at the first speed. The control section 65 turns on the feed clutch 34 to rotate the feed roller 32 so as to feed the medium 99 at the first speed. The control section 65 does not apply a feed force to the medium 99 from the feed roller 32 by turning off the feed clutch 34. In this case, the feed roller 32 may be driven to rotate with respect to the medium 99 to be transported, but does not contribute to the transport of the medium 99. When the leading edge of the medium 99 passes the second curved portion 25 at the first speed, the generation of paper dust and charging are suppressed.

The control section 65 may rotate the feed roller 32 to feed the medium 99 at a speed different from the first speed. For example, the control section 65 may rotate the feed roller 32 to feed the medium 99 at a speed lower than the first speed. In this case, in the second curved portion 25, the possibility that paper dust is generated from the medium 99 or the medium 99 is charged is further reduced. The control section 65 may rotate the feed roller 32 to feed the medium 99 at a speed higher than the first speed. For example, the feed roller 32 may be rotated to feed the medium 99 at a speed higher than the first speed and lower than the second speed. Even in this case, it is possible to reduce the possibility that paper dust is generated from the medium 99 or the medium 99 is charged, compared to a case where the medium 99 is fed at the second speed. In addition, for example, if the transport path 23 does not include the second curved portion 25, the control section 65 may feed the medium 99 at a high speed equal to or higher than the second speed using the feed roller 32.

The control section 65 rotates the feed roller 32 such that the subsequent medium M2 overlaps the preceding medium M1 until a leading edge of the preceding medium M1 reaches the registration roller 44. The control section 65 controls the rotation timing of the feed roller 32 such that the subsequent medium M2 overlaps the preceding medium M1 until the leading edge of the preceding medium M1 reaches the registration roller 44. The control section 65 controls the overlap amount between sheets of the medium 99 by controlling the rotation timing of the feed roller 32. The control section 65 rotates the feed roller 32 such that the overlap amount between the preceding medium M1 and the subsequent medium M2 is sufficient until the leading edge of the preceding medium M1 reaches the registration roller 44. By this, the transport interval between the preceding medium M1 and the subsequent medium M2 is reduced.

When the feed roller 32 feeds the medium 99 at the first speed, the overlap amount of the subsequent medium M2 with respect to the preceding medium M1 is maintained until the leading edge of the preceding medium M1 reaches the registration roller 44. When the feed roller 32 feeds the medium 99 at a speed different from the first speed, the overlap amount of the subsequent medium M2 with respect to the preceding medium M1 changes before the leading edge of the preceding medium M1 reaches the registration roller 44.

The control section 65 rotates the feed roller 32 such that the overlap between the preceding medium M1 and the subsequent medium M2 is eliminated before the leading edge of the subsequent medium M2 reaches the registration roller 44. The control section 65 controls the rotation timing of the feed roller 32 so that the overlap between the preceding medium M1 and the subsequent medium M2 is eliminated before the subsequent medium M2 reaches the recording section 13. That is, the control section 65 rotates the feed roller 32 so that the overlap amount between the preceding medium M1 and the subsequent medium M2 is eliminated before the leading edge of the subsequent medium M2 reaches the registration roller 44. This reduces degradation in the quality. The control section 65 may rotate the feed roller 32 such that the overlap between the preceding medium M1 and the subsequent medium M2 is eliminated before the leading edge of the subsequent medium M2 reaches the recording section 13. The control section 65 may rotate the feed roller 32 such that the overlap between the preceding medium M1 and the subsequent medium M2 is eliminated before the leading edge of the subsequent medium M2 reaches the transport belt 17.

The control section 65 determines the overlap amount between sheets of the medium 99 on the basis of information relating to transport acquired by the acquisition section 61. The control section 65 rotates the feed roller 32 so as to obtain the overlap amount determined based on information relating to transport. For example, in a case where high-speed transport in which a processing speed is emphasized is set, the control section 65 increases the overlap amount between sheets of the medium 99. In a case where low-speed transport in which the quality is emphasized is set, the control section 65 reduces the overlap amount between sheets of the medium 99. The control section 65 can reduce the speed difference between the first speed and the second speed by reducing the overlap amount between sheets of the medium 99. For example, the control section 65 can reduce the overlap amount between sheets of the medium 99, thereby reducing a transport speed of the medium 99 by the registration roller 44. When the speed difference becomes small, it takes time to eliminate the overlap amount, but this can be dealt with by reducing the overlap amount. It can be said that control section 65 determines the overlap amount according to the speed difference between the first speed and the second speed. The overlap amount between sheets of the medium 99 may be determined on the basis of information relating to transport other than a transport speed, and the first speed and the second speed may be determined according to the overlap amount.

The control section 65 controls the transport section 36 to transport the medium 99 at the first speed and the second speed. The control section 65 rotates the transport roller to transport the medium 99 at the first speed. Specifically, the control section 65 rotates the transport rollers so as to transport the medium 99, whose leading edge is positioned at the first curved portion 24, at the first speed. By this, the medium 99, whose leading edge is positioned at the first curved portion 24, is transported at the first speed. The control section 65 may rotate the transport roller so as to transport the medium 99 at the second speed. For example, the control section 65 may rotate the transport roller so as to transport the medium 99, whose leading edge is positioned at the upstream portion 26, at the second speed. The control section 65 may rotate the transport roller so as to transport the medium 99, whose leading edge is positioned on the transport path 23, at the first speed. That is, the control section 65 may rotate the transport roller so as to transport the medium 99 at the first speed on the transport path 23. In this case, the medium 99 is also transported at the first speed at the upstream portion 26.

The control section 65 rotates the registration roller 44 so as to transport the medium 99 at the second speed. The control section 65 rotates the registration roller 44 so as to transport the medium 99, whose leading edge has reached the registration roller 44, at the second speed. Specifically, the control section 65 rotates the registration roller 44 so as to transport the medium 99, whose skew was corrected by the abutment of the leading edge, at the second speed. In a case where the transport roller transports the medium 99 at the first speed, the speed difference is generated between the preceding medium M1 and the subsequent medium M2 when the leading edge of the preceding medium M1 reaches the registration roller 44. For this reason, in a case where the transport roller transports the medium 99 at the first speed, the preceding medium M1 and the subsequent medium M2 are transported while overlapping each other at least until the leading edge of the preceding medium M1 reaches the registration roller 44.

When the medium 99 is fed by the feed roller 32, it reaches the transport roller. Specifically, a leading edge of the medium 99 reaches the third transport roller 39. At this time, in one example, the medium 99 is fed by the feed roller 32 at the first speed and is transported by the third transport roller 39 at the first speed. Since there is no speed difference between the feed roller 32 and the third transport roller 39, the possibility that a load is applied to the medium 99 in contact with the feed roller 32 and the third transport roller 39 is reduced. If there is the speed difference between the feed roller 32 and the third transport roller 39, a load may be applied to the medium 99. Specifically, when the third transport roller 39 pulls the medium 99 from the feed roller 32, there is a possibility that the medium 99 may be stretched. The same applies to the first transport roller 37 and the second transport roller 38. When the medium 99 is transported by the third transport roller 39, it reaches the second transport roller 38. The medium 99 is transported at the first speed by the second transport roller 38. Since there is no speed difference between the feed roller 32 and the second transport roller 38, the possibility that a load is applied to the medium 99 is reduced. The medium 99 reaches the first transport roller 37 by being transported to the second transport roller 38. The medium 99 is transported at the first speed by the first transport roller 37. Since there is no speed difference between the feed roller 32 and the first transport roller 37, the possibility that a load is applied to the medium 99 is reduced. In a case where the leading edge of the medium 99 reaches the transport roller, the feed roller 32 may be switched to a state where a feed force is not applied to the medium 99. Also in this case, the possibility that the medium 99 is stretched is reduced.

When the medium 99 is transported by the transport roller, it reaches the registration roller 44. Specifically, when the medium 99 is transported by the first transport roller 37, it reaches the registration roller 44. The medium 99 is transported at the second speed by registration roller 44.

If there is the speed difference between the registration roller 44 and the transport roller, a load may be applied to the medium 99 in contact with the registration roller 44 and the transport roller. For example, if there is the speed difference between the registration roller 44 and the first transport roller 37, a load may be applied to the medium 99. Specifically, when the registration roller 44 pulls the medium 99 from the first transport roller 37, there is the possibility that the medium 99 is stretched. The same applies to the second transport roller 38 and the third transport roller 39. If there is the speed difference between the registration roller 44 and the second transport roller 38, a load may be applied to the medium 99. If there is the speed difference between the registration roller 44 and the third transport roller 39, a load may be applied to the medium 99.

The control section 65 controls the transport section 36 so that the medium 99 is not stretched by the registration roller 44 and the transport roller. The control section 65 controls the transport roller so that the medium 99 is not stretched by the registration roller 44 and the transport roller. For example, when the leading edge of medium 99 reaches the registration roller 44, the control section 65 switches the transport roller to a state in which a transporting force is not applied to medium 99. In one example, the control section 65 switches the transport roller to a state in which a transporting force is not applied to the medium 99 by turning off the transport clutch. By this, the possibility that the medium 99 is stretched is reduced. The control section 65 may switch the transport roller to a state in which a transporting force is not applied to the medium 99 by separating the transport roller from the driven roller. The control section 65 may control one of the three transport rollers to turn off the transport clutch, and separate the other transport rollers from the driven rollers.

When the leading edge of the preceding medium M1 reaches the registration roller 44 and the transport roller is switched to a state in which a transporting force is not applied to the medium 99, the subsequent medium M2 may not be transported by the transport roller. Therefore, when a trailing edge of the preceding medium M1 passes the transport roller, the control section 65 switches the transport roller to a state in which a transporting force is applied to the medium 99. For example, after the trailing edge of the preceding medium M1 passes the third transport roller 39, the third transport roller 39 is switched to a state in which a transporting force is applied to the medium 99. By this, the third transport roller 39 can transport the subsequent medium M2 without the preceding medium M1 being stretched. The same applies to the first transport roller 37 and the second transport roller 38. After the trailing edge of the preceding medium M1 has passed the second transport roller 38, the control section 65 switches the second transport roller 38 to a state in which a transporting force is applied to the medium 99. After the trailing edge of the preceding medium M1 has passed the first transport roller 37, the control section 65 switches the first transport roller 37 to a state in which a transporting force is applied to the medium 99.

The subsequent medium M2 is fed by the feed roller 32 until the third transport roller 39 is switched to a state of applying a transporting force to the medium 99. After switching the third transport roller 39 to a state in which a transporting force is applied to the medium 99, the control section 65 may switch the feed roller 32 to a state in which a feed force is not applied to the medium 99. In this case, there is little possibility of the feed roller 32 and the transport roller applying a load to the medium 99.

The control section 65 may rotate the transport roller so as to transport the medium 99 at the second speed in order to prevent the medium 99 from being stretched by the registration roller 44 and the transport roller. Specifically, when the leading edge of the medium 99 reaches the registration roller 44, the control section 65 may rotate the transport roller so as to transport the medium 99 at the second speed. In this case, there is no speed difference between the registration roller 44 and the transport roller, so there is little possibility of a load being applied to the medium 99.

When the leading edge of the preceding medium M1 reaches the registration roller 44 and the speed of the transport roller is switched to the second speed, the subsequent medium M2 is transported by the transport roller at the second speed. In this case, there is the possibility that the leading edge of the subsequent medium M2 passes the first curved portion 24 at the second speed. Therefore, when the trailing edge of the preceding medium M1 passes the first transport roller 37, the control section 65 switches the first transport roller 37, the second transport roller 38, and the third transport roller 39 to the first speed. After the trailing edge of the preceding medium M1 has passed the first transport roller 37, the control section 65 rotates the first transport roller 37, the second transport roller 38, and the third transport roller 39 to transport the subsequent medium M2 at the first speed. By this, the subsequent medium M2 is transported at the first speed without the preceding medium M1 being stretched. In this case, when the trailing edge of the preceding medium M1 passes the first transport roller 37, the leading edge of the subsequent medium M2 needs to be positioned upstream of the portion in the first curved portion 24 where the curvature is largest. Therefore, when the trailing edge of the preceding medium M1 passes the first transport roller 37, the control section 65 controls the overlap amount so that the leading edge of the subsequent medium M2 is positioned upstream of the portion in the first curved portion 24 where the curvature is largest.

When the leading edge of the preceding medium M1 reaches the registration roller 44 and the speed of the transport roller is switched to the second speed, the subsequent medium M2 is transported by the transport roller at the second speed. In this case, a load may be applied to the subsequent medium M2 due to the speed difference between the feed roller 32 and the transport roller. Therefore, when the leading edge of the preceding medium M1 reaches the registration roller 44, the control section 65 switches the feed roller 32 to a state where a feed force is not applied to the medium 99. This reduces the possibility that a load is applied to the subsequent medium M2 due to the speed difference between the feed roller 32 and the transport roller. In this case, when the feed roller 32 is switched to a state in which a feed force is not applied, the leading edge of the subsequent medium M2 needs to reach the third transport roller 39. Therefore, when the leading edge of the preceding medium M1 reaches the registration roller 44, the control section 65 controls the overlap amount so that the leading edge of the subsequent medium M2 reaches the third transport roller 39.

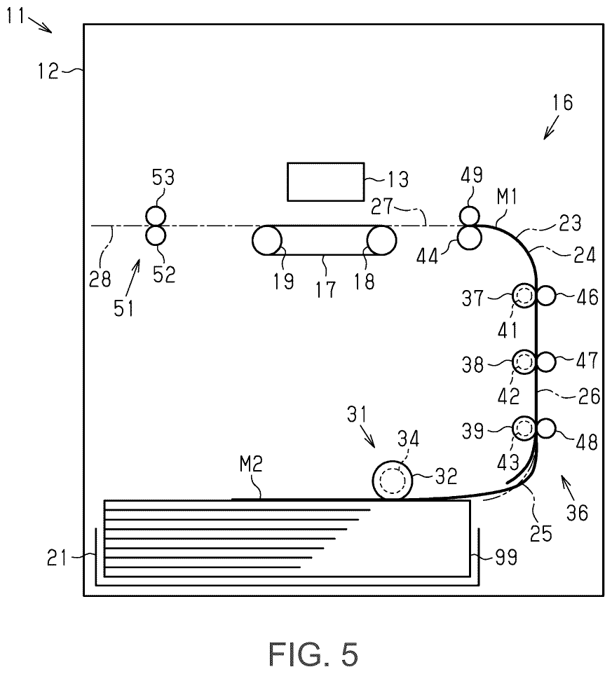

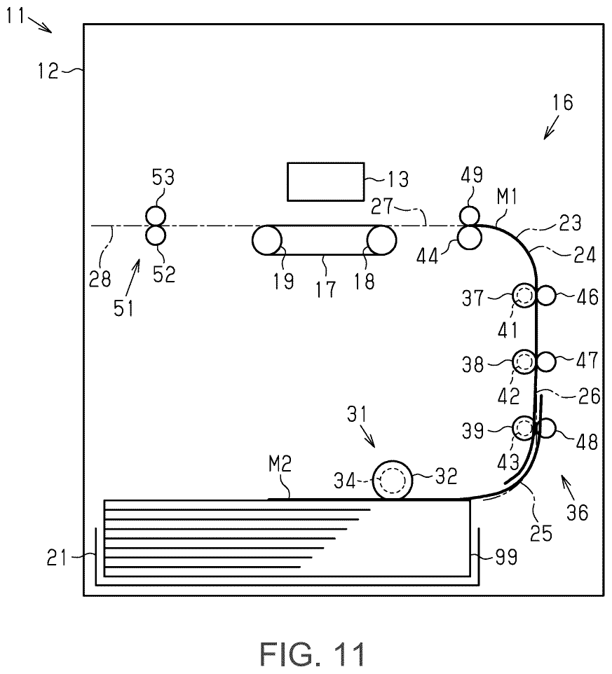

Next, regarding a control for transporting the medium 99 so that the medium 99 is not stretched by the registration roller 44 and the transport roller, a first pattern will be described with reference to FIGS. 5 to 10, and a second pattern will be described with reference to FIGS. 11 to 16. In the following description, a case in which two sheets of medium 99 are continuously transported is taken as an example, but it is needless to say that the present disclosure may be applied to a case in which three or more sheets of medium 99 are transported.

First, the first pattern will be described. The first pattern is a pattern for suppressing stretching of the medium 99 by turning off the transport clutch. In the first pattern, the transport motor 40 always rotates at the first speed.

As shown in FIG. 5, when the leading edge of the preceding medium M1 reaches the registration roller 44, the control section 65 turns off the transport clutch. Specifically, after correcting skew of the preceding medium M1, the control section 65 turns off the first transport clutch 41, the second transport clutch 42, and the third transport clutch 43. In one example, when the leading edge of the preceding medium M1 reaches the registration roller 44, the trailing edge of the preceding medium M1 has not passed the third transport roller 39. When the leading edge of the preceding medium M1 reaches the registration roller 44, the leading edge of the subsequent medium M2 has reached the third transport roller 39.

The control section 65 may detect that the leading edge of the medium 99 reaches the registration roller 44 by the first detection sensor 56. The control section 65 may detect that the leading edge of the medium 99 has reached the registration roller 44 by counting time.

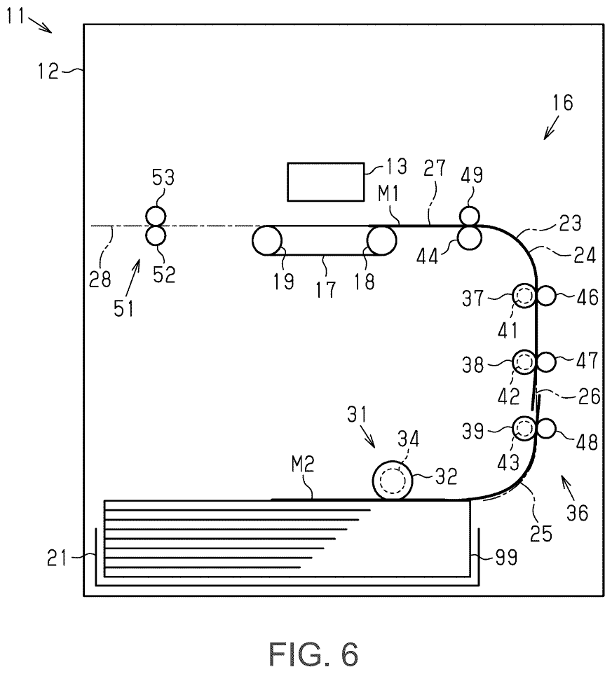

As shown in FIG. 6, the control section 65 rotates the registration roller 44 so as to transport the preceding medium M1 at the second speed. By this, the trailing edge of the preceding medium M1 passes the third transport roller 39. At this time, the control section 65 rotates the third transport roller 39 so as to transport the subsequent medium M2 at the first speed. That is, the control section 65 turns on the third transport clutch 43.

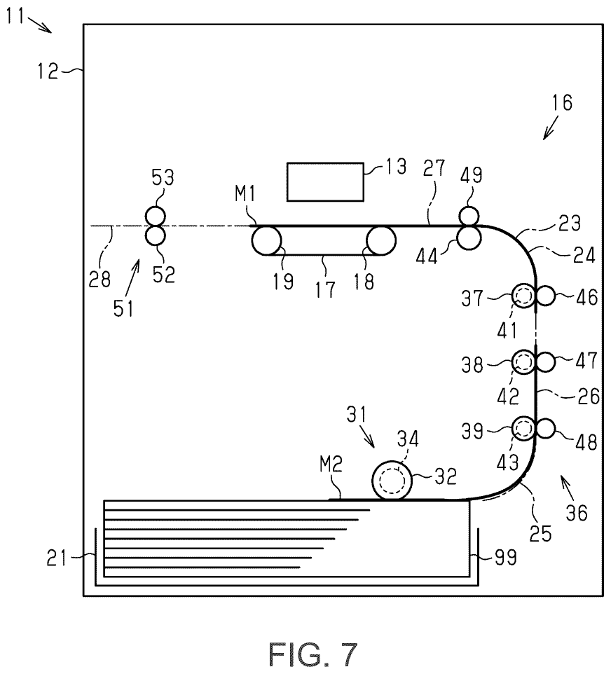

As shown in FIG. 7, when the preceding medium M1 is transported by the registration roller 44, the trailing edge of the preceding medium M1 passes the second transport roller 38. At this time, the control section 65 rotates the second transport roller 38 so as to transport the subsequent medium M2 at the first speed. That is, the control section 65 turns on the second transport clutch 42. In one example, when the trailing edge of the preceding medium M1 passes the second transport roller 38, the overlap between the preceding medium M1 and the subsequent medium M2 is eliminated.

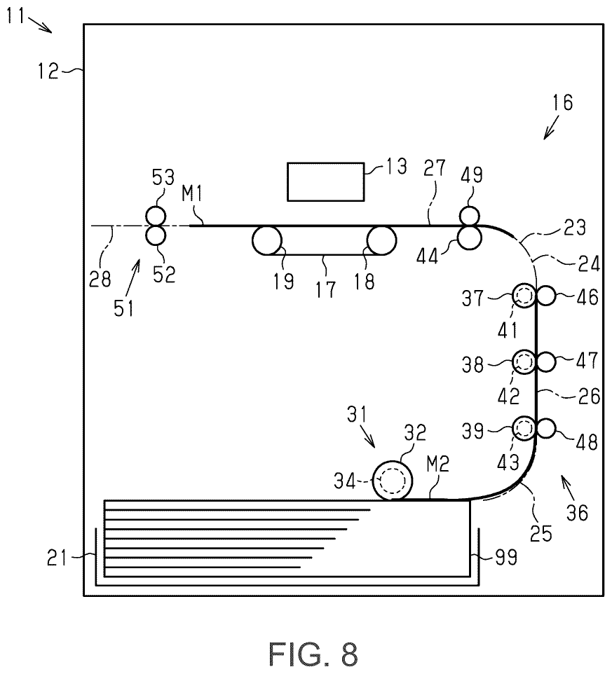

As shown in FIG. 8, when the preceding medium M1 is transported by the registration roller 44, the trailing edge of the preceding medium M1 passes the first transport roller 37. At this time, the control section 65 rotates the first transport roller 37 so as to transport the subsequent medium M2 at the first speed. That is, the control section 65 turns on the first transport clutch 41.

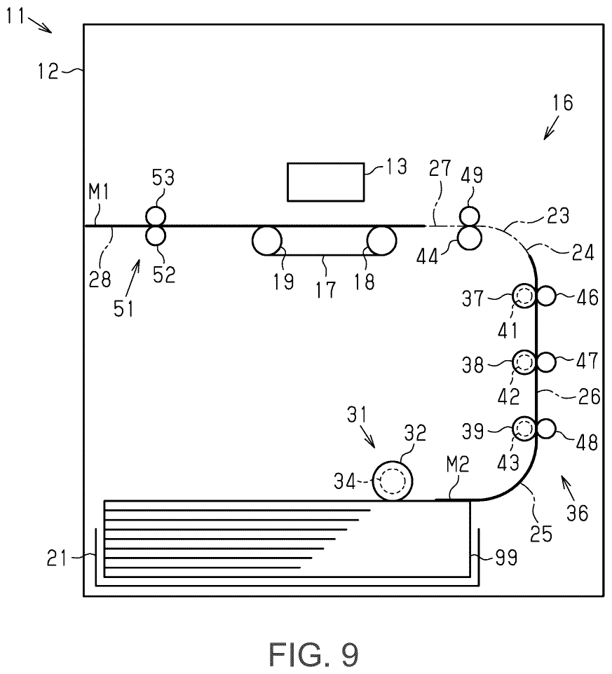

As shown in FIG. 9, when the preceding medium M1 is transported by the registration roller 44, the trailing edge of the preceding medium M1 passes the registration roller 44. At this time, the control section 65 stops the registration roller 44. By this, the registration roller 44 can correct skew of the subsequent medium M2 while continuing the transport of the preceding medium M1. As described above, in order to correct skew of the subsequent medium M2, the trailing edge of the preceding medium M1 needs to pass the registration roller 44 before the leading edge of the subsequent medium M2 reaches the registration roller 44. In one example, when the trailing edge of the preceding medium M1 has passed the registration roller 44, the leading edge of the subsequent medium M2 is positioned at the first curved portion 24.

The control section 65 may detect that the trailing edge of the medium 99 has passed the registration roller 44 by the second detection sensor 57. The control section 65 may detect that the trailing edge of the medium 99 has passed the registration roller 44 by counting time.

The control section 65 rotates the first transport roller 37, the second transport roller 38, and the third transport roller 39 so as to transport the subsequent medium M2, whose leading edge is positioned at the first curved portion 24, at the first speed. By this, in the subsequent medium M2, generation of paper dust, charging, and the like are suppressed.

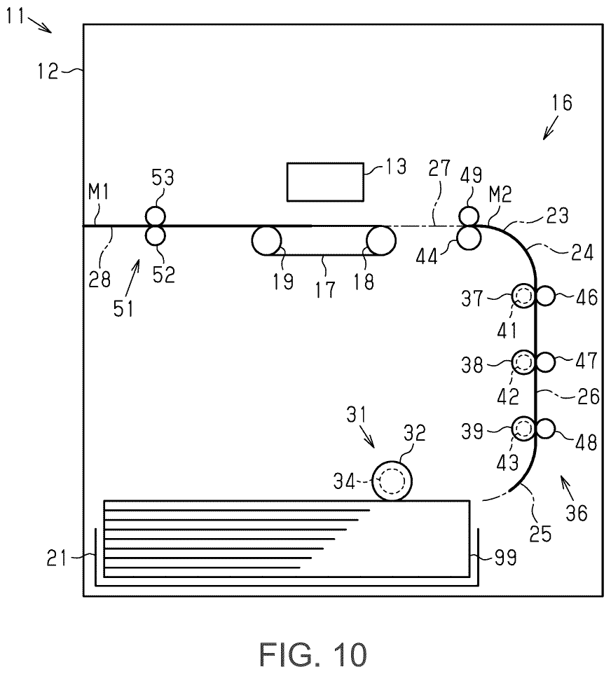

As shown in FIG. 10, when the leading edge of the subsequent medium M2 reaches the registration roller 44, the control section 65 turns off the transport clutch. Specifically, the control section 65 turns off the first transport clutch 41, the second transport clutch 42, and the third transport clutch 43 after correcting skew of the subsequent medium M2. The control section 65 rotates the registration roller 44 to transport the subsequent medium M2 at the second speed.

Next, the second pattern will be described. The second pattern is a pattern for suppressing stretching of the medium 99 by rotating the transport roller at the second speed.

As shown in FIG. 11, when the leading edge of the preceding medium M1 reaches the registration roller 44, the control section 65 rotates the transport roller to transport the preceding medium M1 at the second speed. Specifically, after skew of the preceding medium M1 is corrected, the control section 65 rotates the transport roller so as to transport the preceding medium M1 at the second speed. When the leading edge of the preceding medium M1 reaches the registration roller 44, the control section 65 switches the transport roller from the first speed to the second speed. In one example, when the leading edge of the preceding medium M1 reaches the registration roller 44, the trailing edge of the preceding medium M1 has not passed the third transport roller 39. On the other hand, when the leading edge of the preceding medium M1 reaches the registration roller 44, the leading edge of the subsequent medium M2 has reached the third transport roller 39. That is, the leading edge of the subsequent medium M2 has passed the second curved portion 25. Since the leading edge of the subsequent medium M2 is positioned at the upstream portion 26, there is no problem even if the subsequent medium M2 is transported at the second speed.

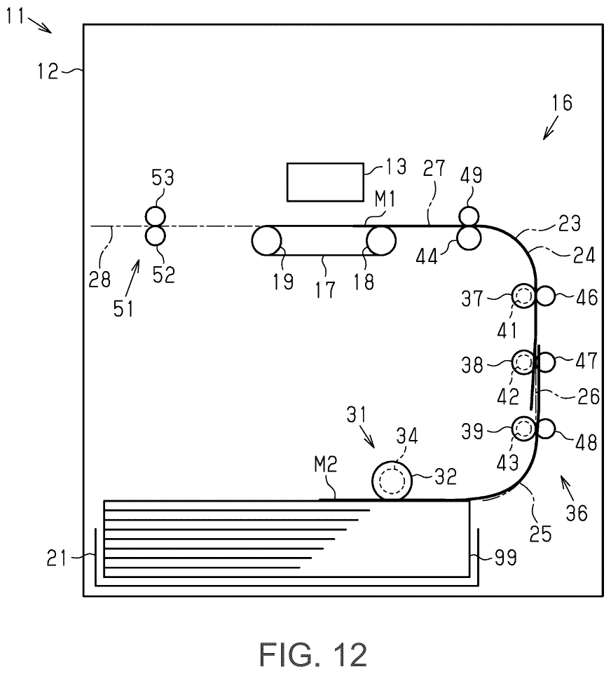

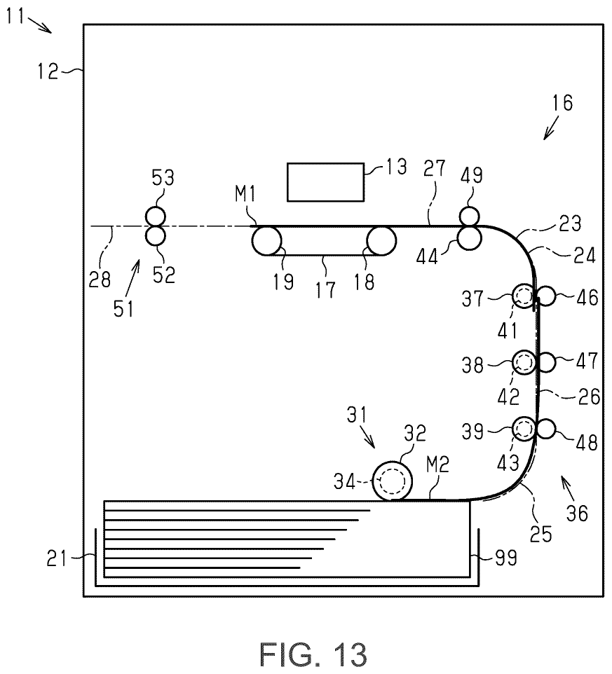

As shown in FIGS. 12 and 13, the control section 65 rotates the registration roller 44 so as to transport the preceding medium M1 at the second speed. The control section 65 rotates the first transport roller 37, the second transport roller 38, and the third transport roller 39 at the second speed so as to transport the preceding medium M1 at the second speed. Accordingly, the subsequent medium M2 is also transported at the second speed.

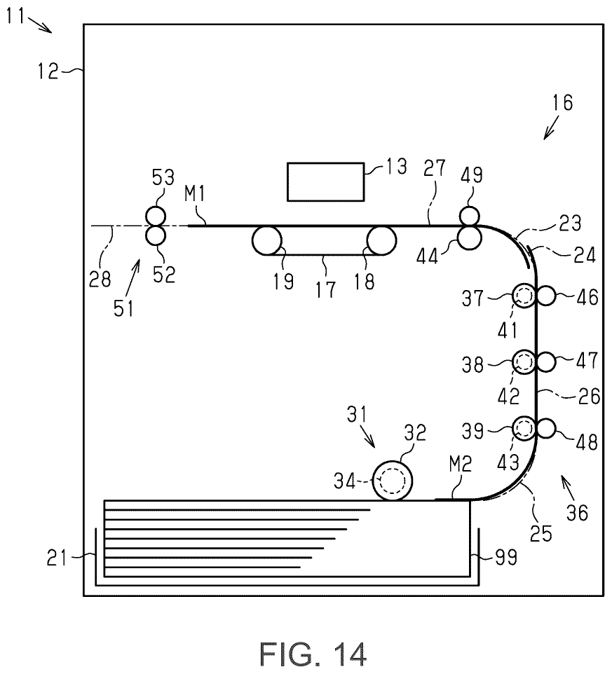

As shown in FIG. 14, when the preceding medium M1 is transported, the trailing edge of the preceding medium M1 passes the first transport roller 37. At this time, the control section 65 rotates the transport roller so as to transport the subsequent medium M2 at the first speed. Specifically, the control section 65 rotates the first transport roller 37, the second transport roller 38, and the third transport roller 39 so as to transport the subsequent medium M2 at the first speed. When the trailing edge of the preceding medium M1 passes the first transport roller 37, the control section 65 switches the transport roller from the first speed to the second speed. In one example, when the trailing edge of the preceding medium M1 passes through the first transport roller 37, the leading edge of the subsequent medium M2 is positioned at the first curved portion 24. The leading edge of the subsequent medium M2 does not pass a portion with the largest curvature in the first curved portion 24. Therefore, since the subsequent medium M2 is transported at the first speed, the generation of paper dust, charging, and the like are suppressed. When the trailing edge of the preceding medium M1 passes the first transport roller 37, the leading edge of the subsequent medium M2 may be positioned at the upstream portion 26.

The leading edge of the subsequent medium M2 passes the first curved portion 24 while the preceding medium M1 and the subsequent medium M2 overlap each other. In this case, the leading edge of the subsequent medium M2 is guided by the preceding medium M1. Therefore, the possibility that the leading edge of the subsequent medium M2 violently rubs against the first curved portion 24 is reduced.

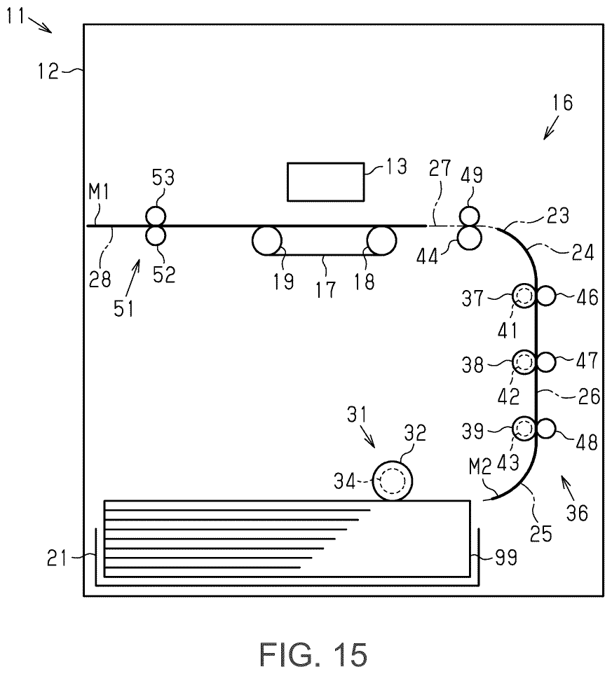

As shown in FIG. 15, when the preceding medium M1 is transported, the trailing edge of the preceding medium M1 passes the registration roller 44. At this time, the control section 65 stops the registration roller 44. By this, the registration roller 44 can correct skew of the subsequent medium M2 while continuing the transport of the preceding medium M1. In order to correct skew of the subsequent medium M2, it is necessary that the trailing edge of the preceding medium M1 passes the registration roller 44 before the leading edge of the subsequent medium M2 reaches the registration roller 44. In one example, when the trailing edge of the preceding medium M1 has passed the registration roller 44, the leading edge of the subsequent medium M2 is positioned at the first curved portion 24.

The control section 65 rotates the first transport roller 37, the second transport roller 38, and the third transport roller 39 so as to transport the subsequent medium M2, whose leading edge is positioned at the first curved portion 24, at the first speed. By this, in the subsequent medium M2, generation of paper dust, charging, and the like are suppressed.

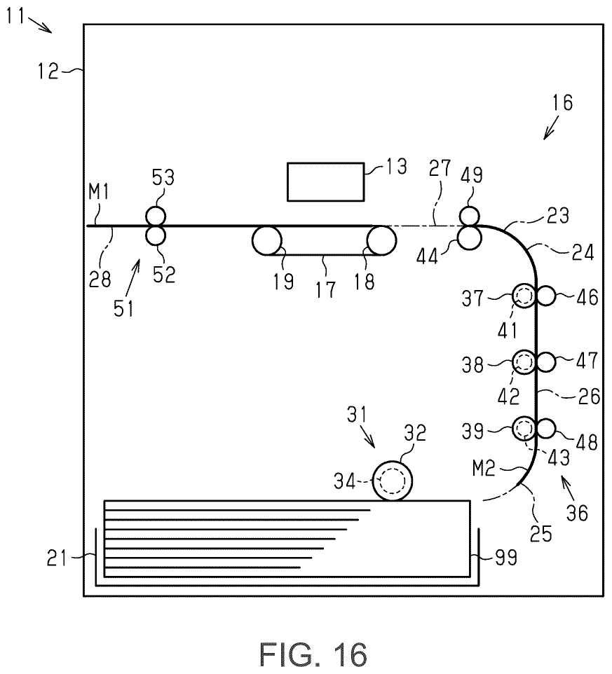

As shown in FIG. 16, when the leading edge of the subsequent medium M2 reaches the registration roller 44, the control section 65 turns off the transport clutch. Specifically, the control section 65 turns off the first transport clutch 41, the second transport clutch 42, and the third transport clutch 43 after correcting skew of the subsequent medium M2. The control section 65 rotates the registration roller 44 to transport the subsequent medium M2 at the second speed.

### Flowchart

Next, a transport process executed by the control section 65 will be described. The transport process is a process of transporting sheets of the medium 99 while overlapping each other. The transport process is started when a user's instruction is input. For example, the control section 65 starts the transport process by selecting the first mode. In the following description, a case in which two sheets of the medium 99 are continuously transported is taken as an example, but it is needless to say that the present disclosure may be applied to a case in which three or more sheets of the medium 99 are transported.

Regarding the transport process, a first transport process and a second transport process will be described. The first transport process is a process of transporting the medium 99 according to the first pattern described above. The second transport process is a process of transporting medium 99 according to the second pattern described above.

First, the first transport process will be described.

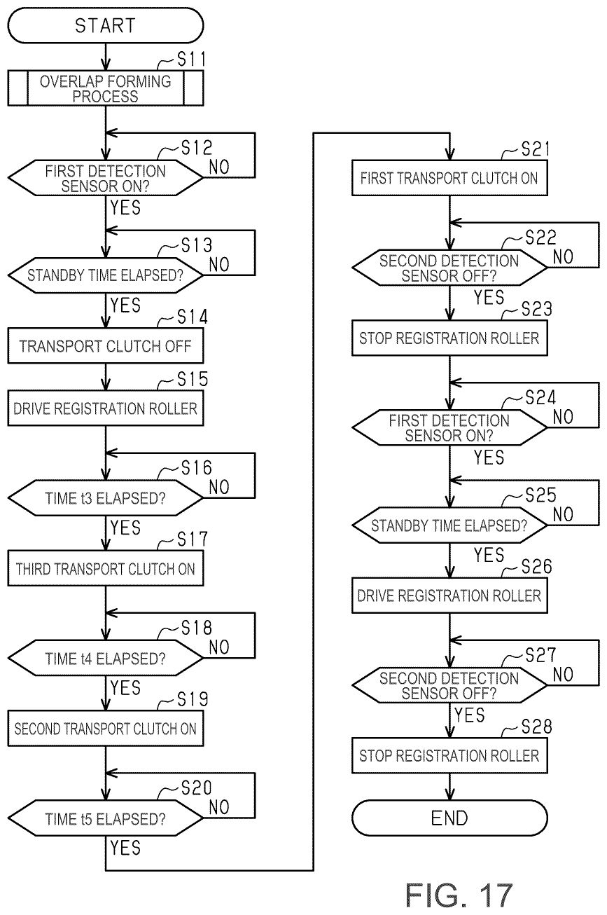

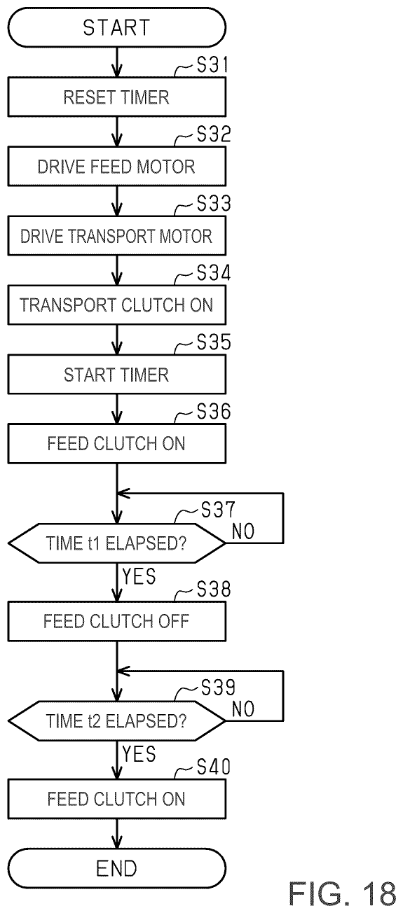

As shown in FIG. 17, the control section 65 starts an overlap forming process in step S11. The overlap forming process is a process of overlapping sheets of the medium 99. The control section 65 feeds the medium 99 while overlapping sheets of the mediums 99 by the overlap forming process. The control section 65 starts the overlap forming process in accordance with the flowchart shown in FIG. 18.

As shown in FIG. 18, the control section 65 resets a timer in step S31. Specifically, the control section 65 resets time counted by itself.

In step S32, the control section 65 drives the feed motor 33. Specifically, the control section 65 drives the feed motor 33 such that the feed roller 32 feeds the medium 99 at the first speed. At this time, since the feed clutch 34 is turned off, the feed roller 32 does not rotate. That is, a feed force is not applied to the medium 99 from the feed roller 32.

In step S33, the control section 65 drives the transport motor 40. Specifically, the control section 65 drives the transport motor 40 such that the medium 99 is transported at the first speed by the transport roller. The control section 65 drives the transport motor 40 so that the medium 99 is transported at the first speed by the first transport roller 37, the second transport roller 38, and the third transport roller 39. At this time, since the first transport clutch 41, the second transport clutch 42, and the third transport clutch 43 are turned off, the first transport roller 37, the second transport roller 38, and the third transport roller 39 do not rotate. That is, a transporting force is not applied to medium 99 from the transport roller.

In step S34, the control section 65 turns on the transport clutch. Specifically, the control section 65 turns on the first transport clutch 41, the second transport clutch 42, and the third transport clutch 43. By this, the first transport roller 37, the second transport roller 38, and the third transport roller 39 rotate.

In step S35, the control section 65 starts the timer. That is, the control section 65 starts counting time. The control section 65 counts time elapsed since the start of the feeding of the medium 99.

In step S36, the control section 65 turns on the feed clutch 34. By this, the feed roller 32 rotates. The preceding medium M1 is fed by the rotation of the feed roller 32. By this, the recording device 11 is in the state shown in FIG. 2.

In step S37, the control section 65 determines whether a time t1 has elapsed. Specifically, the control section 65 determines whether the time t1 has elapsed since step S35. The time t1 may be a time previously stored in the control section 65 or may be a time calculated by the control section 65. The time t1 is a time when the leading edge of medium 99 fed in step S36 is expected to reach the third transport roller 39. That is, in step S37, the control section 65 determines whether the preceding medium M1 has reached the third transport roller 39. When the time t1 has elapsed, the control section 65 shifts the process to step S38. When the time t1 has not elapsed, the control section 65 repeats the process of step S37. The control section 65 may determine whether the preceding medium M1 has reached the third transport roller 39 based on a detection result of a sensor, not limited to the elapse of time.

In step S38, the control section 65 turns off the feed clutch 34. By this, the feed roller 32 is driven to rotate with respect to the preceding medium M1. That is, the feed roller 32 is in a state of not applying a feed force to the preceding medium M1.

In step S39, the control section 65 determines whether a time t2 has elapsed. Specifically, the control section 65 determines whether the time t2 has elapsed since step S35. The time t2 may be a time previously stored in the control section 65 or may be a time calculated by the control section 65. The time t2 is a time for determining the feeding timing of the subsequent medium M2. The time t2 is a time for determining the overlap amount between the preceding medium M1 and the subsequent medium M2. When the time t2 has elapsed, the control section 65 shifts the process to step S40. When the time t2 has not elapsed, the control section 65 repeats the process of step S39.

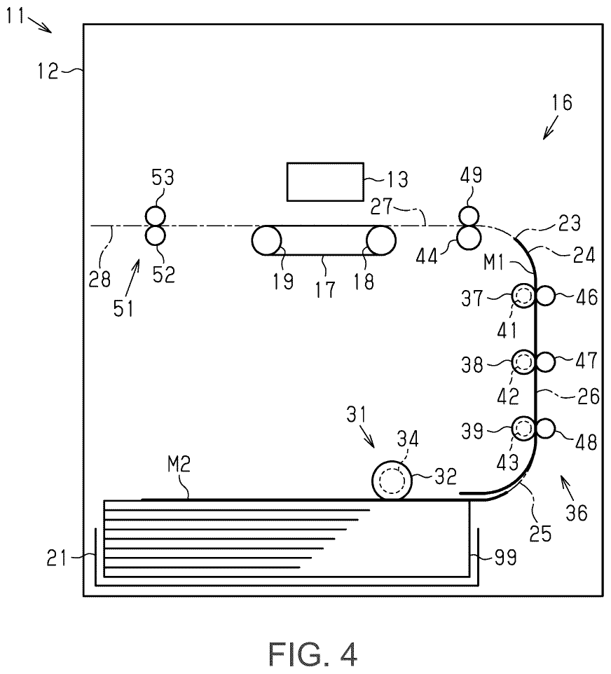

In step S40, the control section 65 turns on the feed clutch 34. By this, the feed roller 32 rotates. The subsequent medium M2 is fed by the rotation of the feed roller 32. That is, the subsequent medium M2 is fed in a state of overlapping the preceding medium M1. By this, the recording device 11 is in the state shown in FIG. 4. When finishing the process of step S40, the control section 65 finishes the overlap forming process. The control section 65 returns to the transport process when the overlap forming process is finished.

As shown in FIG. 17, in step S12, the control section 65 determines whether the first detection sensor 56 is turned ON. That is, the control section 65 determines whether the preceding medium M1 has reached the registration roller 44. The control section 65 may determine whether the preceding medium M1 has reached the registration roller 44 not only by a detection result of the first detection sensor 56 but also by the elapse of time. When the first detection sensor 56 is turned on, the control section 65 shifts the process to step S13. When the first detection sensor 56 is turned off, the control section 65 repeats the process of step S12.

In step S13, the control section 65 determines whether a standby time has elapsed. Specifically, the control section 65 determines whether the standby time has elapsed since step S12. The standby time is a time required for skew correction. That is, in step S13, the leading edge of the preceding medium M1 is abutted against the registration roller 44, thereby correcting skew of the preceding medium M1. When the standby time has elapsed, the control section 65 shifts the process to step S14. When the standby time has not elapsed, the control section 65 repeats the process of step S13.

In step S14, the control section 65 turns off the transport clutch. Specifically, the control section 65 turns OFF the first transport clutch 41, the second transport clutch 42, and the third transport clutch 43. By this, the transport roller is driven to rotate with respect to the preceding medium M1. That is, the transport roller is in a state of not applying a transporting force to the preceding medium M1. At this time, the recording device 11 is in the state shown in FIG. 5. It is sufficient to turn off the transport clutch of the transport roller where the preceding medium M1 is positioned, and when there is the transport roller that the preceding medium M1 has passed, the transport clutch of the transport roller need not be turned off.

In step S15, the control section 65 drives the registration roller 44. Specifically, the control section 65 rotates the registration roller 44 to transport the preceding medium M1 at the second speed.

In step S16, the control section 65 determines whether a time t3 has elapsed. Specifically, the control section 65 determines whether the time t3 has elapsed since step S35. The time t3 is a time at which the trailing edge of the preceding medium M1 is expected to pass the third transport roller 39. That is, in step S16, the control section 65 determines whether the preceding medium M1 has passed the third transport roller 39. When the time t3 has elapsed, the control section 65 shifts the process to step S17. When the time t3 has not elapsed, the control section 65 repeats the process of step S16. The control section 65 may determine whether the preceding medium M1 has passed the third transport roller 39 based on a detection result of a sensor, not limited to the elapse of time.

In step S17, the control section 65 turns on the third transport clutch 43. By this, the third transport roller 39 rotates. The subsequent medium M2 is transported at the first speed by the rotation of the third transport roller 39. At this time, the recording device 11 is in the state shown in FIG. 6. The control section 65 may turn off the feed clutch 34.

In step S18, the control section 65 determines whether a time t4 has elapsed. Specifically, the control section 65 determines whether the time t4 has elapsed since step S35. The time t4 is a time at which the trailing edge of the preceding medium M1 is expected to pass the second transport roller 38. That is, in step S18, the control section 65 determines whether the preceding medium M1 has passed the second transport roller 38. When the time t4 has elapsed, the control section 65 shifts the process to step S19. When the time t4 has not elapsed, the control section 65 repeats the process of step S18. The control section 65 may determine whether the preceding medium M1 has passed the second transport roller 38 based on a detection result of a sensor, not limited to the elapse of time.

In step S19, the control section 65 turns on the second transport clutch 42. By this, the second transport roller 38 rotates. The subsequent medium M2 is transported at the first speed by the rotation of the second transport roller 38. At this time, the recording device 11 is in the state shown in FIG. 7.

In step S20, the control section 65 determines whether a time t5 has elapsed. Specifically, the control section 65 determines whether the time t5 has elapsed since step S35. The time t5 is a time at which the trailing edge of the preceding medium M1 is expected to pass the first transport roller 37. That is, in step S20, the control section 65 determines whether the preceding medium M1 has passed the first transport roller 37. When the time t5 has elapsed, the control section 65 shifts the process to step S21. When the time t5 has not elapsed, the control section 65 repeats the process of step S20. The control section 65 may determine whether the preceding medium M1 has passed the first transport roller 37 based on a detection result of a sensor, not limited to the elapse of time.

In step S21, the control section 65 turns on the first transport clutch 41. By this, the first transport roller 37 rotates. The subsequent medium M2 is transported at the first speed by the rotation of the first transport roller 37. At this time, the recording device 11 is in the state shown in FIG. 8.

In step S22, the control section 65 determines whether the second detection sensor 57 is turned off. That is, the control section 65 determines whether the preceding medium M1 has passed the registration roller 44. The control section 65 may determine whether the preceding medium M1 has passed the registration roller 44 not only by a detection result of the second detection sensor 57 but also by the elapse of time. When the second detection sensor 57 is turned off, the control section 65 shifts the process to step S23. When the second detection sensor 57 is turned on, the control section 65 repeats the process of step S22.

In step S23, the control section 65 stops the registration roller 44. The control section 65 completes the preparation for correcting skew of the subsequent medium M2 by stopping the registration roller 44. At this time, the recording device 11 is in the state shown in FIG. 9. The preceding medium M1 is transported by the transport belt 17, the discharge section 51, and the like.

In step S24, the control section 65 determines whether the first detection sensor 56 is turned on. That is, the control section 65 determines whether the subsequent medium M2 has reached the registration roller 44. The control section 65 may determine whether the subsequent medium M2 has reached the registration roller 44 not only by a detection result of the first detection sensor 56 but also by the elapse of time. When the first detection sensor 56 is turned on, the control section 65 shifts the process to step S25. When the first detection sensor 56 is turned off, the control section 65 repeats the process of step S24.

In step S25, the control section 65 determines whether the standby time has elapsed. Specifically, the control section 65 determines whether the standby time has elapsed since step S24. The standby time is the same time as in step S13. That is, in step S25, the leading edge of the subsequent medium M2 is abutted against the registration roller 44, thereby correcting skew of the subsequent medium M2. When the standby time has elapsed, the control section 65 shifts the process to step S26. When the standby time has not elapsed, the control section 65 repeats the process of step S25.

In step S26, the control section 65 drives the registration roller 44. Specifically, the control section 65 rotates the registration roller 44 so as to transport the subsequent medium M2 at the second speed. At this time, the recording device 11 is in the state shown in FIG. 10.

In step S27, the control section 65 determines whether the second detection sensor 57 is turned off. That is, the control section 65 determines whether the subsequent medium M2 has passed the registration roller 44. The control section 65 may determine whether the subsequent medium M2 has passed the registration roller 44 not only by a detection result of the second detection sensor 57 but also by the elapse of time. When the second detection sensor 57 is turned off, the control section 65 shifts the process to step S28. When the second detection sensor 57 is turned on, the control section 65 repeats the process of step S27.

In step S28, the control section 65 stops the registration roller 44. The subsequent medium M2 is transported by the transport belt 17, the discharge section 51, and the like. When finishing the process of step S28, the control section 65 finishes the first transport process.

As described above, in the first transport process, the control method for the medium transport device 16 includes rotating the transport roller so as to transport the medium 99, whose leading edge is positioned on the transport path 23, at the first speed. The control method for the medium transport device 16 includes rotating the registration roller 44 to convey the medium 99, whose leading edge has reached the registration roller 44, at the second speed. The control method for the medium transport device 16 includes rotating the feed roller 32 so that the subsequent medium M2 overlaps the preceding medium M1 until the leading edge of the preceding medium M1 reaches the registration roller 44.

Next, a second transport process will be described.

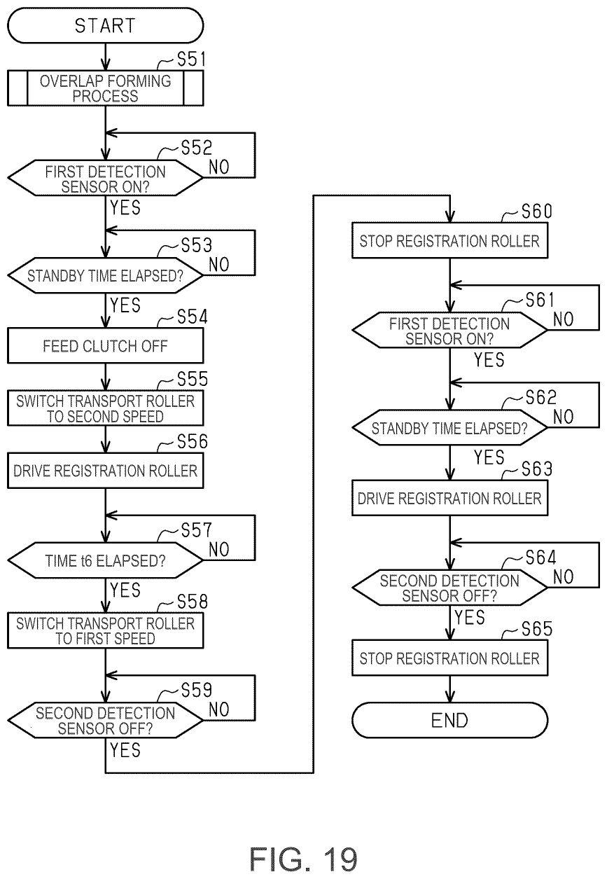

As shown in FIG. 19, the control section 65 starts the overlap forming process in step S51. The process of step S51 is the same as the process of step S11. The control section 65 starts the overlap forming process in accordance with the flowchart shown in FIG. 18.

In step S52, the control section 65 determines whether the first detection sensor 56 is turned on. Step S52 is the same process as step S12. That is, the control section 65 determines whether the preceding medium M1 has reached the registration roller 44. When the first detection sensor 56 is turned on, the control section 65 shifts the process to step S53. When the first detection sensor 56 is turned off, the control section 65 repeats the process of step S52.

In step S53, the control section 65 determines whether the standby time has elapsed. Specifically, the control section 65 determines whether the standby time has elapsed since step S52. The process of step S53 is the same as the process of step S13. That is, in step S53, the leading edge of the preceding medium M1 is abutted against the registration roller 44, thereby correcting skew of the preceding medium M1. When the standby time has elapsed, the control section 65 shifts the process to step S54. When the standby time has not elapsed, the control section 65 repeats the process of step S53.

In step S54, the control section 65 turns off the feed clutch 34. By this, the feed roller 32 is driven to rotate with respect to the subsequent medium M2. That is, the feed roller 32 is in a state of not applying a feed force to the subsequent medium M2.

In step S55, the control section 65 switches the transport roller to the second speed. Specifically, the control section 65 rotates the transport roller so as to transport the preceding medium M1 at the second speed. The control section 65 controls the transport motor 40 to rotate the first transport roller 37, the second transport roller 38, and the third transport roller 39 so as to transport the preceding medium M1 at the second speed. As the preceding medium M1 is transported at the second speed, the subsequent medium M2 is also transported at the second speed. At this time, the recording device 11 is in the state shown in FIG. 11.

In step S56, the control section 65 drives the registration roller 44. Specifically, the control section 65 rotates the registration roller 44 to transport the preceding medium M1 at the second speed.

In step S57, the control section 65 determines whether a time t6 has elapsed. Specifically, the control section 65 determines whether the time t6 has elapsed since step S35. The time t6 is a time when the trailing edge of the preceding medium M1 is expected to have passed the first transport roller 37. That is, in step S57, the control section 65 determines whether the preceding medium M1 has passed the first transport roller 37. When the time t6 has elapsed, the control section 65 shifts the process to step S58. When the time t6 has not elapsed, the control section 65 repeats the process of step S57. The control section 65 may determine whether the preceding medium M1 has passed the first transport roller 37 based on a detection result of a sensor, not limited to the elapse of time.

In step S58, the control section 65 switches the transport roller to the first speed. Specifically, the control section 65 rotates the transport roller so as to transport the subsequent medium M2 at the first speed. The control section 65 controls the transport motor 40 to rotate the first transport roller 37, the second transport roller 38, and the third transport roller 39 so as to transport the subsequent medium M2 at the first speed. By this, the preceding medium M1 is transported at the first speed, while the subsequent medium M2 is transported at the first speed. At this time, the recording device 11 is in the state shown in FIG. 14.

In step S59, the control section 65 determines whether the second detection sensor 57 is turned off. The control section 65 determines whether the preceding medium M1 has passed the registration roller 44. The control section 65 may determine whether the preceding medium M1 has passed the registration roller 44 not only by a detection result of the second detection sensor 57 but also by the elapse of time. When the second detection sensor 57 is turned off, the control section 65 shifts the process to step S60. When the second detection sensor 57 is turned on, the control section 65 repeats the process of step S59.

In step S60, the control section 65 stops the registration roller 44. The control section 65 completes the preparation for correcting skew of the subsequent medium M2 by stopping the registration roller 44. At this time, the recording device 11 is in the state shown in FIG. 15. The preceding medium M1 is transported by the transport belt 17, the discharge section 51, and the like.

In step S61, the control section 65 determines whether the first detection sensor 56 is turned on. The control section 65 determines whether the subsequent medium M2 has reached the registration roller 44. The control section 65 may determine whether the subsequent medium M2 has reached the registration roller 44 not only by a detection result of the first detection sensor 56 but also by the elapse of time. When the first detection sensor 56 is turned on, the control section 65 shifts the process to step S62. When the first detection sensor 56 is turned off, the control section 65 repeats the process of step S61.

In step S62, the control section 65 determines whether the standby time has elapsed. Specifically, the control section 65 determines whether the standby time has elapsed since step S61. In step S62, the leading edge of the subsequent medium M2 is abutted against the registration roller 44, thereby correcting skew of the subsequent medium M2. At this time, the recording device 11 is in the state shown in FIG. 16. When the standby time has elapsed, the control section 65 shifts the process to step S63. When the standby time has not elapsed, the control section 65 repeats the process of step S62.

In step S63, the control section 65 drives the registration roller 44. Specifically, the control section 65 drives the registration roller 44 to transport the subsequent medium M2 at the second speed. At this time, the control section 65 may switch the transport roller to the second speed in the same manner as in step S55, or may turn off the transport clutch in the same manner as in step S14.

In step S64, the control section 65 determines whether the second detection sensor 57 is turned off. That is, the control section 65 determines whether the subsequent medium M2 has passed the registration roller 44. The control section 65 may determine whether the subsequent medium M2 has passed the registration roller 44 not only by a detection result of the second detection sensor 57 but also by the elapse of time. When the second detection sensor 57 is turned off, the control section 65 shifts the process to step S65. When the second detection sensor 57 is turned on, the control section 65 repeats the process of step S64.

In step S65, the control section 65 stops the registration roller 44. The subsequent medium M2 is transported by the transport belt 17, the discharge section 51, and the like. When finishing the process of step S65, the control section 65 finishes the second transport process.

As described above, in the second transport process, the control method for the medium transport device 16 includes rotating the transport rollers so as to transport the medium 99, whose leading edge is positioned at the first curved portion 24, at the first speed. The control method for the medium transport device 16 includes rotating the transport roller so as to transport the medium 99, whose leading edge is positioned at the upstream portion 26, at the second speed. The control method for the medium transport device 16 includes rotating the registration roller 44 to convey the medium 99, whose leading edge has reached the registration roller 44, at the second speed. The control method for the medium transport device 16 includes rotating the feed roller 32 so that the subsequent medium M2 overlaps the preceding medium M1 until the leading edge of the preceding medium M1 reaches the registration roller 44.

### Operations and Effects of the Embodiment

Next, operations and effects of the above-described embodiment will be described.
(1) The control section 65 rotates the transport roller to transport the medium 99 at the first speed. The control section 65 rotates the registration roller 44 to transport the medium 99 at the second speed. The control section 65 rotates the feed roller 32 such that the subsequent medium M2 overlaps the preceding medium M1 until the leading edge of the preceding medium M1 reaches the registration roller 44. According to the above-described configuration, the medium 99, whose leading edge is positioned at the first curved portion 24, is transported by the transport roller at the first speed, which is relatively low. By this, the possibility that paper dust is generated from the medium 99 or the medium 99 is charged is reduced. Since the feed roller 32 feeds the medium 99 such that the subsequent medium M2 overlaps the preceding medium M1, a decrease in a processing speed is suppressed.
(2) The control section 65 rotates the transport roller so as to transport the medium 99, whose leading edge is positioned on the transport path 23, at the first speed. According to the above-described configuration, the medium 99, whose leading edge is positioned on the transport path 23, is transported by the transport roller at the first speed, which is relatively low. By this, the possibility that paper dust is generated from the medium 99 or the medium 99 is charged is reduced.
(3) When the leading edge of the medium 99 reaches the registration roller 44, the control section 65 switches the transport roller to a state in which a transporting force is not applied to the medium 99. The medium 99 whose leading edge reaches the registration roller 44 is transported by the registration roller 44 at the second speed, which is relatively high. At this time, a transporting force is not applied from the transport roller to the medium 99 whose leading edge reaches the registration roller 44. Therefore, according to the above-described configuration, the possibility of the medium 99, whose leading edge reaches the registration roller 44, being stretched by the registration roller 44 and the transport roller is reduced.
(4) The control section 65 rotates the feed roller 32 so that the overlap between the preceding medium M1 and the subsequent medium M2 is eliminated before the leading edge of the subsequent medium M2 reaches the registration roller 44. According to the above-described configuration, the preceding medium M1 passes the registration roller 44 before the subsequent medium M2 reaches the registration roller 44. Therefore, after the preceding medium M1 passes the registration roller 44, the subsequent medium M2 abuts against the registration roller 44. By this, skew of the subsequent medium M2 is smoothly corrected.
(5) After the preceding medium M1 has passed the second transport roller 38, the control section 65 rotates the second transport roller 38 so as to transport the subsequent medium M2 at the first speed. According to the above-described configuration, it is possible to transport the subsequent medium M2 by the second transport roller 38 while reducing the possibility that the preceding medium M1 is stretched by the registration roller 44 and the second transport roller 38.
(6) The control section 65 rotates the transport roller so as to transport the medium 99, whose leading edge is positioned at the first curved portion 24, at the first speed. The control section 65 rotates the transport roller to transport the medium 99, whose leading edge is positioned at the upstream portion 26, at the second speed. According to the above-described configuration, the medium 99, whose leading edge is positioned at the first curved portion 24, is transported by the transport roller at the first speed, which is relatively low. By this, the possibility that paper dust is generated from the medium 99 or the medium 99 is charged is reduced. The medium 99, whose leading edge is positioned at the upstream portion 26, is transported by the transport roller at the second speed, which is relatively high. By this, a decrease in processing speed is more effectively suppressed.
(7) The control section 65 rotates the feed roller 32 such that the overlap between the preceding medium M1 and the subsequent medium M2 is eliminated before the leading edge of the subsequent medium M2 reaches the registration roller 44. According to the above-described configuration, the preceding medium M1 passes the registration roller 44 before the subsequent medium M2 reaches the registration roller 44. Therefore, after the preceding medium M1 passes registration roller 44, the subsequent medium M2 can abut against the registration roller 44. By this, skew of the subsequent medium M2 is smoothly corrected.
(8) The control section 65 rotates the transport roller so as to transport the preceding medium M1 and the subsequent medium M2 at the second speed until the preceding medium M1 passes the transport roller. According to the above-described configuration, in the upstream portion 26, the medium 99 is transported by the transport roller at the second speed, which is relatively high. By this, a decrease in processing speed is more effectively suppressed.
(9) The control section 65 rotates the transport roller to transport the subsequent medium M2 at the first speed after the preceding medium M1 passes the transport roller. According to the above-described configuration, the possibility of the preceding medium M1 being stretched by the registration roller 44 and the transport roller is reduced, while the subsequent medium M2 can be transported by the transport roller.
(10) The control section 65 rotates the feed roller 32 so as to feed the medium 99, whose leading edge is positioned at the second curved portion 25, at the first speed. According to the above-described configuration, the medium 99 whose leading edge is positioned at the second curved portion 25 is fed by the feed roller 32 at the first speed, which is relatively low. By this, the possibility that paper dust is generated from the medium 99 or the medium 99 is charged is reduced.
(11) The control section 65 rotates the feed roller 32 so as to feed the medium 99 at the first speed. According to the above-described configuration, the possibility that paper dust is generated from the medium 99 or the medium 99 is charged is reduced.
(12) The control section 65 determines the overlap amount between the preceding medium M1 and the subsequent medium M2 based on information acquired by the acquisition section 61. Depending on the length of the medium 99, a transport method, or the like, the first speed may change or the second speed may change. When the first speed, the second speed, or the like changes, it is necessary to change the overlap amount between the preceding medium M1 and the subsequent medium M2. According to the above-described configuration, an appropriate overlap amount is determined based on information relating to transport of medium 99. By this, a processing speed is maintained based on the information relating to transport of the medium 99.
(13) The control section 65 selects the first mode or the second mode based on information acquired by the acquisition section 61. According to the above-described configuration, it is possible to transport the preceding medium M1 and the subsequent medium M2 without overlapping in the second mode.
(14) The medium transport device 16 continuously transports the medium 99 during recording. According to the above-described configuration, since the overlap between the preceding medium M1 and the subsequent medium M2 is eliminated before the leading edge of the subsequent medium M2 reaches the registration roller 44, skew of the subsequent medium M2 can be corrected by the registration roller 44.
(15) The transport belt 17 is positioned downstream of the registration roller 44. According to the above-described configuration, the transport belt 17 attracts the medium 99 that has passed the registration roller 44. This stabilizes the posture of the medium 99.

### Modifications

The above-described embodiment can be modified as follows. The above-described embodiment and the following modifications can be implemented in combination with each other to the extent that they are not technically contradictory.

The medium transport device 16 may be applied to an image reading device that reads an image of the medium 99. The image reading device is, for example, a scanner or an automatic document reading device (ADF). In this case, the acquisition section 61 may acquire a reading method of the medium 99 as information relating to transport of the medium 99. The control section 65 may determine the overlap amount between sheets of the medium 99 based on the reading method of the medium 99.

The transport section 36 may include another roller positioned upstream of the registration roller 44. The control section 65 may change a transport speed of the medium 99 or eliminate the overlap amount based on the roller.

Liquid ejected by the recording section 13 is not limited to ink, and may be, for example, a liquid body in which particles of a functional material are dispersed or mixed in liquid. For example, the recording section 13 may eject a liquid body including a material such as electrode material or pixel material used for manufacturing a liquid crystal display, an electroluminescent display, or a surface emitting display in a dispersed or dissolved form.

At least a part of the feed motor 33, the transport motor 40, and the registration motor 45 may be a common motor as long as it is possible to appropriately change a speed.

The acquisition sensor 62 is not limited to an optical sensor, and may be a mechanical sensor or an ultrasonic sensor. A plurality of sensors may be combined.

When the overlap amount is determined based on information relating to transport, the control section 65 may calculate the overlap amount based on the information, or the control section 65 may select the overlap amount based on a predetermined relationship between the information and the overlap amount.

### Technical Ideas

Hereinafter, technical ideas grasped from the above-described embodiment and modifications, and operations and effects thereof, will be described.

(A) A medium transport device includes a feed roller that feeds a medium; a transport roller that transports the medium fed by the feed roller; a registration roller that corrects skew of the medium transported by the transport roller; a transport path extending from the feed roller toward the registration roller; and a control section that rotates the transport roller so as to transport the medium at a first speed and that rotates the registration roller so as to transport the medium at a second speed that is higher than the first speed, wherein the transport path includes a curved portion extending while curving between the transport roller and the registration roller and the control section rotates the feed roller such that a subsequent medium fed next after a preceding medium overlaps the preceding medium until a leading edge of the preceding medium reaches the registration roller.

According to the above-described configuration, the medium whose leading edge is positioned at the curved portion is transported by the transport roller at the first speed, which is relatively low. By this, the possibility that paper dust is generated from the medium or the medium is charged is reduced. A decrease in a processing speed is suppressed by the feed roller feeding the medium such that the subsequent medium overlaps the preceding medium. The subsequent medium may overlap the preceding medium at least until the leading edge of the preceding medium reaches the registration roller, and the subsequent medium may overlap the preceding medium even after the leading edge of the preceding medium reaches the registration roller.
(B) The above-described medium transport device may be configured such that the control section rotates the transport roller so as to transport the medium whose leading edge is positioned on the transport path at the first speed.

According to the above-described configuration, the medium whose leading edge is positioned on the transport path is transported by the transport roller at the first speed, which is relatively low. By this, the possibility that paper dust is generated from the medium or the medium is charged is reduced.

(C) The above-described medium transport device may be configured such that when the leading edge of the medium reaches the registration roller, the control section switches the transport roller to a state of not applying a transporting force to the medium.

The medium whose leading edge reaches the registration roller is transported by the registration roller at the second speed, which is relatively high. At this time, a transporting force is not applied from the transport roller to the medium whose leading edge reaches the registration roller. Therefore, according to the above-described configuration, the possibility that the medium whose leading edge reaches the registration roller is stretched by the registration roller and the transport roller is reduced.

(D) The above-described medium transport device may be configured such that the control section rotates the feed roller such that an overlap between the preceding medium and the subsequent medium is eliminated before a leading edge of the subsequent medium reaches the registration roller.

According to the above-described configuration, the preceding medium passes the registration roller before the subsequent medium reaches the registration roller. Therefore, after the preceding medium passes the registration roller, the subsequent medium abuts against the registration roller. By this, skew of the subsequent medium is smoothly corrected.

(E) The above-described medium transport device may be configured such that the transport roller is a first transport roller, the medium transport device includes a second transport roller positioned upstream of the first transport roller, and the control section rotates the second transport roller so as to transport the subsequent medium at the first speed after the preceding medium passes the second transport roller.

According to the above-described configuration, it is possible to transport the subsequent medium by the second transport roller while reducing the possibility that the preceding medium is stretched by the registration roller and the second transport roller. The possibility that the preceding medium transported at the second speed is stretched by the first transport roller is reduced.

(F) The above-described medium transport device may be configured such that the transport path includes an upstream portion positioned upstream of the curved portion, the upstream portion is a portion having a smaller curvature than the curved portion, and the control section rotates the transport roller so as to transport the medium whose leading edge is positioned at the curved portion at the first speed, and rotates the transport roller so as to transport the medium whose leading edge is positioned at the upstream portion at the second speed.

According to the above-described configuration, the medium whose leading edge is positioned at the curved portion is transported by the transport roller at the first speed, which is relatively low. By this, the possibility that paper dust is generated from the medium or the medium is charged is reduced. The medium whose leading edge is positioned at the upstream portion is transported by the transport roller at the second speed, which is relatively high. By this, a decrease in a processing speed is suppressed.

(G) The above-described medium transport device may be configured such that the control section rotates the feed roller such that an overlap between the preceding medium and the subsequent medium is eliminated before a leading edge of the subsequent medium reaches the registration roller.

According to the above-described configuration, the preceding medium passes the registration roller before the subsequent medium reaches the registration roller. Therefore, after the preceding medium passes the registration roller, the subsequent medium can abut against the registration roller. By this, skew of the subsequent medium is smoothly corrected.

(H) The above-described medium transport device may be configured such that the curved portion is positioned between the upstream portion and the registration roller, the transport roller is positioned at the upstream portion, and the control section rotates the transport roller so as to transport the preceding medium and the subsequent medium at the second speed until the preceding medium passes the transport roller.

According to the above-described configuration, in the upstream portion, the medium is transported by the transport roller at the second speed, which is relatively high. By this, a decrease in a processing speed is suppressed.

(I) The above-described medium transport device may be configured such that the control section rotates the transport roller so as to transport the subsequent medium at the first speed after the preceding medium passes the transport roller.

According to the above-described configuration, it is possible to transport the subsequent medium by the transport roller while reducing the possibility that the preceding medium is stretched by the registration roller and the transport roller.

(J) The above-described medium transport device may be configured such that the curved portion is a first curved portion, the transport path includes a second curved portion positioned upstream of the upstream portion, the second curved portion is a portion with having a larger curvature than the upstream portion, the feed roller feeds the medium along the second curved portion, and the control section rotates the feed roller so as to feed the medium whose leading edge is positioned at the second curved portion at the first speed.

According to the above-described configuration, the medium whose leading edge is positioned at the second curved portion is fed by the feed roller at the first speed, which is relatively low. By this, the possibility that paper dust is generated from the medium or the medium is charged is reduced.

(K) The above-described medium transport device may be configured such that the control section rotates the feed roller so as to feed the medium at the first speed.

According to the above-described configuration, the possibility that paper dust is generated from the medium or the medium is charged is reduced.

(L) The above-described medium transport device may be configured such that the medium transport device further includes an acquisition section that acquires information relating to transport of the medium, wherein the control section determines an overlap amount between the preceding medium and the subsequent medium based on the information acquired by the acquisition section.

Depending on the length of the medium, a transport method, or the like, the first speed may change or the second speed may change. When the first speed, the second speed, or the like changes, it is necessary to change the overlap amount between the preceding medium and the subsequent medium. According to the above-described configuration, an appropriate overlap amount is determined based on information relating to transport of the medium. By this, a processing speed is maintained based on the information relating to transport of the medium.

(M) The above-described medium transport device may be configured such that an acquisition section that acquires information relating to transport of the medium, wherein based on the information acquired by the acquisition section, the control section selects a first mode in which the feed roller is rotated such that the preceding medium and the subsequent medium overlap each other, or a second mode in which the feed roller is rotated such that the preceding medium and the subsequent medium do not overlap each other.

According to the above-described configuration, it is also possible to transport the preceding medium and the subsequent medium without overlapping each other by the second mode.

(N) A recording device includes the above-described medium transport device and a recording section that records an image on the medium transported by the medium transport device, wherein the medium transport device continuously transports the medium on which recording is being performed by the recording section.

According to the above-described configuration, since the overlap between the preceding medium and the subsequent medium is eliminated before the leading edge of the subsequent medium reaches the registration roller, skew of the subsequent medium can be corrected by the registration roller.

(O) The above-described recording device may be configured such that the medium transport device includes a transport belt that faces the recording section and that, while attracting the medium to itself, transports the medium on which recording is performed by the recording section and the transport belt is positioned downstream of the registration roller.

According to the above-described configuration, the medium that has passed the registration roller is attracted to the transport belt. This stabilizes the posture of the medium.

(P) A recording device includes the above-described medium transport device and a recording section that records an image on the medium transported by the medium transport device.

According to the above-described configuration, in the recording device, a decrease in a processing speed is suppressed.

(Q) A control method for a medium transport device, the medium transport device including a feed roller that feeds a medium, a transport roller that transports the medium fed by the feed roller, a registration roller that corrects skew of the medium transported by the transport roller, and a transport path extending from the feed roller toward the registration roller, wherein the transport path includes a curved portion extending while curving between the transport roller and the registration roller, the control method includes rotating the transport roller so as to transport the medium whose leading edge is positioned on the transport path at a first speed; rotating the registration roller so as to transport the medium whose leading edge has reached the registration roller at a second speed that is higher than the first speed; and rotating the feed roller such that a subsequent medium fed after a preceding medium overlaps with the preceding medium until a leading edge of the preceding medium reaches the registration roller.

According to the above-described method, the medium whose leading edge is positioned on the transport path is transported by the transport roller at the first speed, which is relatively low. By this, the possibility that paper dust is generated from the medium or the medium is charged is reduced. A decrease in a processing speed is suppressed by the feed roller feeding the medium such that the subsequent medium overlaps the preceding medium.

(R) A control method for a medium transport device, the medium transport device including a feed roller that feeds a medium, a transport roller that transports the medium fed by the feed roller, a registration roller that corrects skew of the medium transported by the transport roller, and a transport path extending from the feed roller toward the registration roller, wherein the transport path includes a curved portion extending while curving between the transport roller and the registration roller, and an upstream portion positioned upstream of the curved portion and having a curvature smaller than that of the curved portion, the control method includes rotating the transport roller so as to transport the medium whose leading edge is positioned at the curved portion at a first speed; rotating the transport roller so as to transport the medium whose leading edge is positioned at the upstream portion at a second speed that is higher than the first speed; rotating the registration roller so as to transport the medium whose leading edge has reached the registration roller at the second speed; and rotating the feed roller such that a subsequent medium fed after a preceding medium overlaps with the preceding medium until a leading edge of the preceding medium reaches the registration roller.

According to the above-described method, the medium whose leading edge is positioned at the curved portion is transported by the transport roller at the first speed, which is relatively low. By this, the possibility that paper dust is generated from the medium or the medium is charged is reduced. A decrease in a processing speed is suppressed by the feed roller feeding the medium such that the subsequent medium overlaps the preceding medium.

What is claimed is:

1. A medium transport device comprising:
a feed roller that feeds a medium;
a transport roller that transports the medium fed by the feed roller;
a registration roller that corrects skew of the medium transported by the transport roller;
a transport path extending from the feed roller toward the registration roller; and
a control section that rotates the transport roller so as to transport the medium at a first speed and that rotates the registration roller so as to transport the medium at a second speed that is higher than the first speed, wherein
the transport path includes a curved portion extending while curving between the transport roller and the registration roller and
the control section rotates the feed roller such that a subsequent medium fed next after a preceding medium overlaps the preceding medium until a leading edge of the preceding medium reaches the registration roller.

2. The medium transport device according to claim 1, wherein
the control section rotates the transport roller so as to transport the medium whose leading edge is positioned on the transport path at the first speed.

3. The medium transport device according to claim 2, wherein
when the leading edge of the medium reaches the registration roller, the control section switches the transport roller to a state of not applying a transporting force to the medium.

4. The medium transport device according to claim 2, wherein
the control section rotates the feed roller such that an overlap between the preceding medium and the subsequent medium is eliminated before a leading edge of the subsequent medium reaches the registration roller.

5. The medium transport device according to claim 2, wherein
the transport roller is a first transport roller,
the medium transport device includes a second transport roller positioned upstream of the first transport roller, and
the control section rotates the second transport roller so as to transport the subsequent medium at the first speed after the preceding medium passes the second transport roller.

6. The medium transport device according to claim 1, wherein
the transport path includes an upstream portion positioned upstream of the curved portion,
the upstream portion is a portion having a smaller curvature than the curved portion, and
the control section rotates the transport roller so as to transport the medium whose leading edge is positioned at the curved portion at the first speed, and rotates the transport roller so as to transport the medium whose leading edge is positioned at the upstream portion at the second speed.

7. The medium transport device according to claim 6, wherein
the control section rotates the feed roller such that an overlap between the preceding medium and the subsequent medium is eliminated before a leading edge of the subsequent medium reaches the registration roller.

8. The medium transport device according to claim 6, wherein
the curved portion is positioned between the upstream portion and the registration roller,
the transport roller is positioned at the upstream portion, and
the control section rotates the transport roller so as to transport the preceding medium and the subsequent medium at the second speed until the preceding medium passes the transport roller.

9. The medium transport device according to claim 8, wherein
the control section rotates the transport roller so as to transport the subsequent medium at the first speed after the preceding medium passes the transport roller.

10. The medium transport device according to claim 6, wherein
the curved portion is a first curved portion,
the transport path includes a second curved portion positioned upstream of the upstream portion,
the second curved portion is a portion with having a larger curvature than the upstream portion,
the feed roller feeds the medium along the second curved portion, and
the control section rotates the feed roller so as to feed the medium whose leading edge is positioned at the second curved portion at the first speed.

11. The medium transport device according to claim 1, wherein
the control section rotates the feed roller so as to feed the medium at the first speed.

12. The medium transport device according to claim 11, further comprising:
an acquisition section that acquires information relating to transport of the medium, wherein
the control section determines an overlap amount between the preceding medium and the subsequent medium based on the information acquired by the acquisition section.

13. The medium transport device according to claim 1, further comprising:
an acquisition section that acquires information relating to transport of the medium, wherein
based on the information acquired by the acquisition section, the control section selects a first mode in which the feed roller is rotated such that the preceding medium and the subsequent medium overlap each other, or a second mode in which the feed roller is rotated such that the preceding medium and the subsequent medium do not overlap each other.

14. A recording device comprising:
the medium transport device according to claim 4 and
a recording section that records an image on the medium transported by the medium transport device, wherein
the medium transport device continuously transports the medium on which recording is being performed by the recording section.

15. The recording device according to claim 14, wherein
the medium transport device includes a transport belt that faces the recording section and that, while attracting the medium to itself, transports the medium on which recording is performed by the recording section and
the transport belt is positioned downstream of the registration roller.

16. A recording device comprising:
the medium transport device according to claim 1 and
a recording section that records an image on the medium transported by the medium transport device.

17. A control method for a medium transport device, the medium transport device including a feed roller that feeds a medium, a transport roller that transports the medium fed by the feed roller, a registration roller that corrects skew of the medium transported by the transport roller, and a transport path extending from the feed roller toward the registration roller, wherein the transport path includes a curved portion extending while curving between the transport roller and the registration roller,
the control method comprising:
rotating the transport roller so as to transport the medium whose leading edge is positioned on the transport path at a first speed;
rotating the registration roller so as to transport the medium whose leading edge has reached the registration roller at a second speed that is higher than the first speed; and
rotating the feed roller such that a subsequent medium fed after a preceding medium overlaps with the preceding medium until a leading edge of the preceding medium reaches the registration roller.

18. A control method for a medium transport device, the medium transport device including a feed roller that feeds a medium, a transport roller that transports the medium fed by the feed roller, a registration roller that corrects skew of the medium transported by the transport roller, and a transport path extending from the feed roller toward the registration roller, wherein the transport path includes a curved portion extending while curving between the transport roller and the registration roller, and an upstream portion positioned upstream of the curved portion and having a curvature smaller than that of the curved portion,
the control method comprising:
rotating the transport roller so as to transport the medium whose leading edge is positioned at the curved portion at a first speed;
rotating the transport roller so as to transport the medium whose leading edge is positioned at the upstream portion at a second speed that is higher than the first speed;
rotating the registration roller so as to transport the medium whose leading edge has reached the registration roller at the second speed; and
rotating the feed roller such that a subsequent medium fed after a preceding medium overlaps with the preceding medium until a leading edge of the preceding medium reaches the registration roller.
